(19) United States
(12) Patent Application Publication
(10) Pub. No.: US 2008/0228518 A1
(43) Pub. Date: Sep. 18, 2008

(54) System and method for computing energy market models and tradable indices including energy market visualization and trade order entry to facilitate energy risk management

(76) Inventors: E. Russell Braziel, Golden, CO (US); Porter B. Bennett, Evergreen, CO (US); James H. Simpson, Parker, CO (US)

Correspondence Address: Bakos & Kritzer, LLP, 27 Laurel Avenue, Summit, NJ, 07901, US

(21) Appl. No.: 12/152,426

(22) Filed: May 14, 2008

Related U.S. Application Data
(63) Continuation of application No. 11/712,626, filed on Mar. 1, 2007.

(51) Int. Cl. G06Q 99/00

(52) U.S. Cl. 705/1

(57) ABSTRACT

A system and method are disclosed for providing energy market participants with visual market order information, the ability to execute trades and the ability to hedge against risks associated with the energy industry. The system and method entail automatically retrieving, compiling and displaying energy market information to potential market participants.

### RELATED APPLICATIONS

This application is a continuation of application Ser. No. 11/712,626, filed Mar. 1, 2007 and also claims the benefit of U.S. Provisional Patent Application Ser. No. 60/778,723 filed Mar. 3, 2006, both of which are fully incorporated herein by reference.

### FIELD OF THE INVENTION

The present invention generally relates to the field of energy market transactions, including the purchase, sale and trading of energy products and commodities. More specifically, the present invention relates to a system and method to facilitate energy risk management that provides for visual entry of market order data whereby physical flows of energy are geospatially depicted within the same user interface as are energy prices and transactable energy bids and offers. Also the present invention relates to the creation of indices using a database of aggregated data representing the physical flow of energy through transportation or transmission networks. Also, the present invention relates to the use of market indices created by utilizing a database of aggregated market-energy fundamentals data for the purpose of energy risk management. Accordingly, all market participants (producers, consumers, transportation/transmission network operators, intermediaries, etc.) are afforded a novel opportunity to hedge against risks inherent in the energy marketplace.

### BACKGROUND OF THE INVENTION

The energy marketplace is a complex, dynamic, and sometimes volatile environment where buyers and sellers of energy commodities such as natural gas, electric power, crude oil, coal, motor gasoline and other products transact business. Successful participants involved in this marketplace, including investors, operators, producers, utilities, traders, marketers and regulators place a significant value on prompt, accurate market information. This information can come from a variety of sources. For example, pricing information often comes from regulated futures markets and various price reporting services covering unregulated or over-the-counter markets. Also, trade publications disseminate news stories about various aspects of the different energy industries. Statistics that track the performance of each energy industry come from both government and private sources. Within the respective energy industries, such performance statistics are known as market fundamentals. By carefully and continuously monitoring energy pricing information, news stories, and market fundamentals, those participating in energy industries can make assessments and decisions regarding their activities in the energy marketplace. In recent years, as the entire energy complex has become more volatile due to such factors as increasing demand, tighter supplies, and political turmoil, the need for prompt, accurate market information about the energy industry has intensified significantly.

No aspect of this need for accurate market information is more important than participants' use of market fundamentals to assess energy supply, transportation, transmission and demand developments. Hydrocarbon-based energy is a depleting resource, and new sources of hydrocarbons are continuously required to meet demand. Demand for hydrocarbon-based energy is constantly increasing globally, particularly for electric generation and transportation purposes. As has long been the case, the sources of hydrocarbon production are developed far from the areas of consumption. Because all forms of energy comprise physical commodities that are usually produced in locations hundreds or thousands of miles from where the energy is used, the transportation/transmission assets and logistics utilized to transport such energy commodities from producer to end-user are very important components of the industry's value chain. These transportation/transmission assets connect energy producers to energy consumers using complex networks which continuously adjust energy flows in order to balance localized energy supply and demand. As an example of such a complex network, almost all natural gas transportation in North America is currently achieved via pipeline. That is, hundreds of field gathering systems, long line systems and local distribution systems crisscross the continent in a network of pipeline infrastructure. Storage facilities are also integral to the ability of the natural gas industry to meet winter space heating demands. To understand natural gas supply, transportation, storage and demand development, participants in the natural gas market must expend significant time and resources to attempt to utilize the best market fundamentals data available. As another example, pipeline transportation in North America is equally important in the crude oil market. In contrast, with respect to the global crude oil market marine transportation via crude oil tanker is a vital aspect of the transportation network in that marketplace. For electric power, the analog is the network of transmission lines and utility systems providing connectivity between power generators and end-user.

Energy buying and selling activity tends to be concentrated in certain geographic locations. These locations, known as “hubs”, are generally located where a significant number of connections exist between components of an energy transportation/transmission network. While most hubs develop naturally as a result of the simplification of commercial processes or accommodation of the physical requirement of an energy commodity, some hubs are mandated by regulatory fiat. While buying and selling activity at energy hubs makes up the preponderance of energy trading in most markets, other purchases and sales are made at other locations geographically remote from hub locations. However, pricing for these non-hub transactions are usually based on a differential between transportation/transmission cost and a hub-based price. For this reason, hub pricing and transportation/transmission cost differentials from any trading location to one or more hubs are important aspects of energy markets.

With respect to all energy markets (whether trades are conducted at hubs or not) market fundamentals data is typically generated through the activities of producing, moving and consuming energy. Market participants utilize a variety of methods and sources to glean as much of this market data as possible, and attempt to process the information to use advantageously. Some of the market fundamentals data about the energy industry is provided by private sources. For example, the Hughes Rig Count provides a tally of active crude oil and natural gas drilling rigs—an indication of future supply availability. The active market participant would locate that information and attempt to extrapolate market fundamentals data from the Hughes Rig Count. The most widely utilized sources of market fundamentals data relating to supply and demand data are provided by government agencies. For example, state agencies such as the Texas Railroad Commission, the Oklahoma Corporation Commission, and the Wyoming Oil and Gas Conservation Commission provide information about natural gas and crude oil produced within the borders of their respective states.

In the United States, the most prolific producer of energy information is the United States Federal Government in the auspices of the Energy Information Administration (“EIA”), a statistical agency of the United States Department of Energy. The EIA provides data, forecasts and analyses related to all forms of energy to a wide range of government and private sector decision-makers. The EIA provides a great volume of statistical data, most of which is collected through surveys. Various energy industry participants must periodically submit survey forms to the EIA—such surveys are then used as the basis for the statistical information that EIA then provides to the energy industry.

While the scope of the EIA and state market fundamentals data is broad, the timing of the availability of the information is largely problematic for industry decision-makers. That is, data on energy supply and demand is often several months old (and frequently incomplete) by the time it is published. Furthermore, due to the nature of the survey-based data collection process, the data is frequently subject to later revision. Thus the data may not be reliable as an indication of true energy industry fundamentals. When used to support energy buying and selling strategies, data unreliability is extremely problematic. Similarly, relevant information related to hydrocarbon imports and exports is typically not available until weeks after the import period. Even such basic information such as crude oil and natural gas storage data (which EIA estimates using a sample of industry participants) is not available until several days after the sampling. Thus, there is a clearly established need in the energy industry for more prompt, accurate information regarding gas market fundamentals data.

Fortunately for the energy industry there are other sources of market fundamentals data in addition to federal and state sources. While these sources tend to vary by industry segment, they are often associated with the activities of transporting energy from the point of production to the point of consumption. This is because energy transportation/transmission generally tends to be the aspect of the energy value chain that is most heavily regulated. That is, the government regulation frequently requires the collection and public dissemination of data regarding the movement of energy commodities. Of course, data is also available from the production and end-use applications of the value chain, but data from energy transportation/transmission sources tends to be more abundant.

By way of example, there is a comprehensive set of timely fundamental data available in the United States natural gas market. In the late 1980s when the Federal Energy Regulatory Commission (“FERC”) initiated the process of deregulating natural gas prices and transportation capacity, FERC also instituted certain rules designed to provide greater market transparency to industry participants. These rules have been expanded over time, culminating in an extensive set of procedures issued on Mar. 4, 1997 in Order No. 587-C. Among these rules was a standard promulgated by the Gas Industry Standards Board, (now the North American Energy Standards Board) in Standard 4.3.6 requiring all interstate pipelines in the United States to post “operationally available pipeline capacity” on their company websites several times each day. In effect, this operationally available capacity posting requires all pipelines to post the volume of all natural gas that they receive, transport, store and deliver within a delivery period each day. With respect to posting available capacity, the pipelines are required to provide “[t]imely access to information relevant to the availability of all transportation services, including, but not limited to, the availability of capacity at receipt points, on the mainline, at delivery points, and in storage fields, whether the capacity is available directly from the pipeline or through capacity release, the total design capacity of each point or segment on the system, the amount scheduled at each point or segment whenever capacity is schedule, and all planned and actual service outages or reductions in service capacity.”

The effect of the rules is that interstate pipelines must post the volume of gas flowing through each receipt point, delivery point, meter and storage location on their systems. The early postings indicate what is scheduled to flow in the day ahead. The later or “intraday” postings show the final schedule and accurately represent actual physical flows.

Thus, raw pipeline data on gas flows is theoretically available for near-real-time analysis of supply, transportation, storage and demand. However, such data is posted independently by each pipeline in a wide variety of formats and structures. The presentation of the data is designed for scheduling purposes and provides little or no aggregated information necessary to make the information usable for analytic purposes. The result is that the raw pipeline gas flow and capacity data is extremely unorganized, complex and difficult to interpret analytically. Because the structure and format of the data posted by each pipeline varies so greatly, this “raw” natural gas flow and capacity data has proved to be virtually useless to decision-makers.

Similar sources of near real-time market data are available in other energy sectors. For example, in the United States electric power industry, Independent System Operators (“ISOs”) that operate the networks of transmission lines in various regional markets compile large amounts of data on the generation and load associated with their networks, as well as utilization statistics regarding the networks themselves. Like Natural Gas Flow Data, this “raw” ISO data is structured and formatted differently by each ISO and of little use to those who wish to analyze the information analytically.

Consequently, while this “raw” energy fundamentals data is available from a variety of sources, to make it usable for decision-makers it would need to be processed, transformed and presented in such a way that participants in the energy industry can quickly understand and act upon the analytically analyzed information.

With respect to utilization of analytical information, energy decision-makers often use derivative-based instruments to manage risks associated with weather, government storage estimates, future energy prices, and a variety of other indicators. There are several energy markets which provide a trading venue these instruments, including the New York Mercantile Exchange (NYMEX), the Intercontinental Exchange (ICE) on-line energy transaction platform and direct counterparty-to-counterparty transactions in the over-the-counter (OTC) market.

Each of these market venues exhibit trading of a wide range of energy-related derivative instruments, including futures contracts, options contracts, and basis swaps (e.g., contracts which are valued based on the difference between the NYMEX futures contract and various regional market price indices as reported by trade publications). Interdealer broker ICAP provides a market for derivative instruments based on government indices, otherwise known as Economic Derivatives, such as the NYMEX/ICAP auction markets for the weekly change in natural gas storage and the weekly change in crude oil inventories. These markets are linked to the Energy Information Agency's natural gas and crude oil inventory statistics. A market in weather derivatives with values associated with heating and cooling degree days in various regional markets is provided by the Chicago Mercantile Exchange.

For most participants in the energy industry, the most obvious risk to hedge against is the adverse movement of price. In fact, NYMEX is a popular exchange for price hedging and basis swaps involving both national price levels and regional price differentials. Energy end-users are therefore able to protect themselves against high prices, while energy producers can protect themselves against price declines.

The ICAP auctions on the EIA crude oil and natural gas storage numbers provide companies the ability to hedge earnings based on the value of storage assets. For example, a utility may have leased natural gas storage capacity for seasonal use. If the EIA storage statistic reveals that storage capacity is relatively empty (and thus highly available to market participants) the value of the utility's lease could decline substantially. ICAP's EIA auction gives that utility the ability to hedge against this risk by placing a “put” on the EIA storage number.

Similarly, CME weather futures, options and other weather derivatives available in the market allow companies to hedge against risks associated with variances in the heating or cooling degree days. For example, an electric utility's earnings are at risk if the weather is cooler than expected during the summer season. For such a utility, cooler weather correlates with a reduced demand for power, thereby decreasing the utility's energy sales. Cooler than expected weather may also impact price (hedgible on NYMEX or OTC markets), but the weather futures/derivative allows the utility to hedge the risk of a sales volume decline as well as a potential price decline.

While all of these techniques are useful in the right circumstances, they do not address a number of important market risks that face energy companies. Many companies' earnings are at risk not only because of weather, storage and the commodity gas price, but also because of the risk associated with total energy flows. By way of example, consider the associated risks of industry participants in the natural gas industry:

When gas flows are high, distribution companies (e.g., pipelines) achieve higher earnings because the throughput of natural gas increases. Conversely when flows are down, revenues are down.

When capacity is fully utilized, many pipelines and local distribution companies have the right to curtail industrial customers to insure that residential heating demand is satisfied. Therefore, when gas flows are high in the market area, industrial companies are at risk of having their fuel supply curtailed.

As pipeline capacity utilization nears 100%, pipelines are required to prorate (i.e., allocate) that capacity according to certain presubscribed rules. Therefore, when gas flows are high or capacity is curtailed, gas producers are at risk of having their ability to deliver gas to the market prorated. The revenues of gas producers can be severely impacted by such allocations that require that they limit their sales of gas production.

Of course, the above is merely exemplary, as similar risks are inherent in other energy markets including electric power, crude oil, coal, and motor gasoline.

As described above, weather fluctuations can influence the magnitude of energy flows. However, there are many other factors that can impact energy flows, including economic activity (e.g., factories shutting down or starting up), mechanical problems (e.g., compressors out, pipeline explosions, transmission line outages), supply curtailments (e.g., due to hurricanes or other natural disasters), transportation system construction (e.g., new construction or expansion of existing systems), capacity contracts which constrain deliveries, or even commercial contracts that require specific levels of capacity utilization.

In all such cases, there is currently no viable hedging tool available to industry participants tied to energy flows which would enable such a hedging program for business risks associated with changes in the flow of energy from producer to end-user. What is needed, therefore, are broadly based tradable indices and related derivative instruments which can be used by industry decision-makers as risk management tools for aspects of their business activities which are impacted by changing energy flows.

Traditionally the purchase and sale of energy commodities and energy risk management instruments was conducted in relatively inefficient markets with market participants contacting each other (for OTC transactions) or financial institutions (for exchange transactions) via the telephone or facsimile machine. In the case of exchanges, verbal orders were typically communicated to an open outcry trading pit where transactions were consummated using arcane hand signals and paper tickets. These processes were notoriously labor intensive and error-prone, resulting in high transaction costs for both the buyers and the sellers of such commodities.

More recently, computer systems and networks have begun replacing the arcane system described above. For example, the ICE currently provides an electronic trading platform for conducting a wide range of energy-related transactions. Also, NYMEX recently began to offer electronic trading during regular open outcry trading hours through an alliance with the Chicago Mercantile Exchange, and has reported net trading volume records on several occasions.

With electronic trading becoming the dominant mechanism to effect energy transactions and risk management strategies, it is no longer necessary for transactions to be communicated by telephone. More specifically, order entry for a wide range of energy transactions can now be submitted via a computer communicating with servers that utilize an application programmer interface (API) to provide appropriate security and order validation functions.

With respect to these electronic markets, energy order entry is generally accomplished via a tabular grid on which a user enters descriptive information such as volume, price, location, timeframe and other elements of the transaction. Usually this grid is one component of a system which also provides current market prices and historical price data for markets relevant to the user's order being placed. The user enters the order and it is transmitted over a network (private or public) to the trading venue.

Currently, energy order trading systems fail to integrate energy market fundamentals data. That is, there is no way for market participants to receive information about market fundamentals data on a geospatial basis in near real-time. More specifically, current solutions do not allow market participants to visually perceive important market fundamentals data in order to react to a potentially volatile energy marketplace.

In addition, current energy order trading systems do not utilize visual user interface tools for the entry of energy market orders. Today's market participant must utilize several distinct systems to receive information, compile information, analyze information, and enter energy market orders. None of the available tools allow market participants to visualize the information on a geospatial basis or to enter market orders relating to the visually-based information.

It is clear that a need exists for a system and method to facilitate energy risk management that is based on market information that is organized, tangible, neutral, transparent, and accessible in real-time. Likewise, a need exists for a system and method that provides a comprehensive summary of market fundamentals data to the energy marketplace, and provides summaries that visually represent such information on a geospatial basis and can facilitate the market participant's understanding of market developments in real-time. Finally, it is clear that a need exists for a system and method to facilitate energy risk management that allows for visual market order entry, including the creation of indices using a database of aggregated data representing energy values.

### SUMMARY OF THE INVENTION

The present invention provides a system and method to facilitate participation in the energy market by creating (1) visualization of energy flows to enhance the energy market participant's understanding of market fundamentals data; (2) tradable indices to allow an energy market participant to manage risks inherent in the energy industry; and (3) an integrated mechanism to allow the market participant to execute trade orders within the visual context of energy flows in an energy marketplace.

The present invention also combines the means for the market participant to visualize and understand market fundamentals data with a system and method for effecting decisions based on the information.

One object of the present invention is to provide a system and method for market analysis based on data that is verifiable, neutral and available in real-time.

Another object of the present invention is to provide a system and method that presents available information visually to facilitate the rapid understanding of market developments.

Yet another object of the present invention is to provide a system and method for creating tradable indices based on the analytical analysis of energy flow data.

A further object of the present invention is to allow energy market participants to utilize tradable indices that hedge against various industry risks associated with the energy marketplace.

Another object of the present invention is to provide a system and method for effecting trades in the energy marketplace whereby energy industry participants recognize developments in energy markets in near real-time.

Yet another object of the present invention is to provide a system and method for effecting trades in the energy marketplace whereby energy industry participants assess the implications of developments in the energy on their business activities.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 depicts the system and method to facilitate energy risk management in accordance with the preferred embodiment of the present invention.

FIG. 2 depicts an illustration of a Market Model Template Table Schema in accordance with the preferred embodiment of the present invention.

FIG. 3 depicts an example of the illustration of a representative energy network in accordance with the preferred embodiment of the present invention.

FIG. 4 depicts an example of Market Balance Aggregation in accordance with the preferred embodiment of the present invention.

FIG. 5 depicts an example of an Energy Visual in accordance with the preferred embodiment of the present invention.

FIG. 6 depicts an illustration of an Energy Visuals Template Table Schema in accordance with the present invention.

FIG. 7 depicts an illustration of a Energy Index Template Table Schema in accordance with the present invention.

FIG. 8 shows a flow chart depicting the preferred embodiment for the calculation of a Hub Flow Index Average.

FIG. 9 depicts an exemplary derivative instrument in accordance with one aspect of the present invention.

FIG. 10 depicts an example of the association between an Energy Visual and Market Order Entry System in accordance with the preferred embodiment of the present invention.

FIG. 11 shows the flow of visual energy trading in accordance with the preferred embodiment of the present invention.

FIG. 12 shows Energy Market Fundamentals Gas Market Supply Models as an example of a Market Model in accordance with the preferred embodiment of the present invention.

FIG. 13 shows North America Natural Gas Hub Flow Map as an example of an Energy Visual in accordance with the preferred embodiment of the present invention.

FIG. 14 shows North America Natural Gas Hub Pipeline Capacity Map as an example of an Energy Visual in accordance with the preferred embodiment of the present invention.

FIG. 15 shows North America Natural Gas Storage Capacity Map as an example of an Energy Visual in accordance with the preferred embodiment of the present invention.

FIG. 16 shows North America Hub Flow Map as an example of an Energy Visual in accordance with the preferred embodiment of the present invention.

FIG. 17A depicts Chicago Regional Natural Gas Hub Detail Map as an example of the Regional Natural Gas Hub Detail Maps associated with the present invention.

FIG. 17B depicts Chicago Regional Numerical Table as an example of a numerical table reference page that provides the values used to generate graphical components of the Chicago Regional Natural Gas Hub Detail Map depicted in FIG. 17A.

FIG. 18A depicts Natural Gas Gulf Demand Market Model as an example of a Market Model in connection with the present invention.

FIG. 18B depicts Natural Gas Gulf Demand Market Model Template Table Schema as an example of the information utilized to generate the Natural Gas Gulf Demand Market Model of FIG. 18A.

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

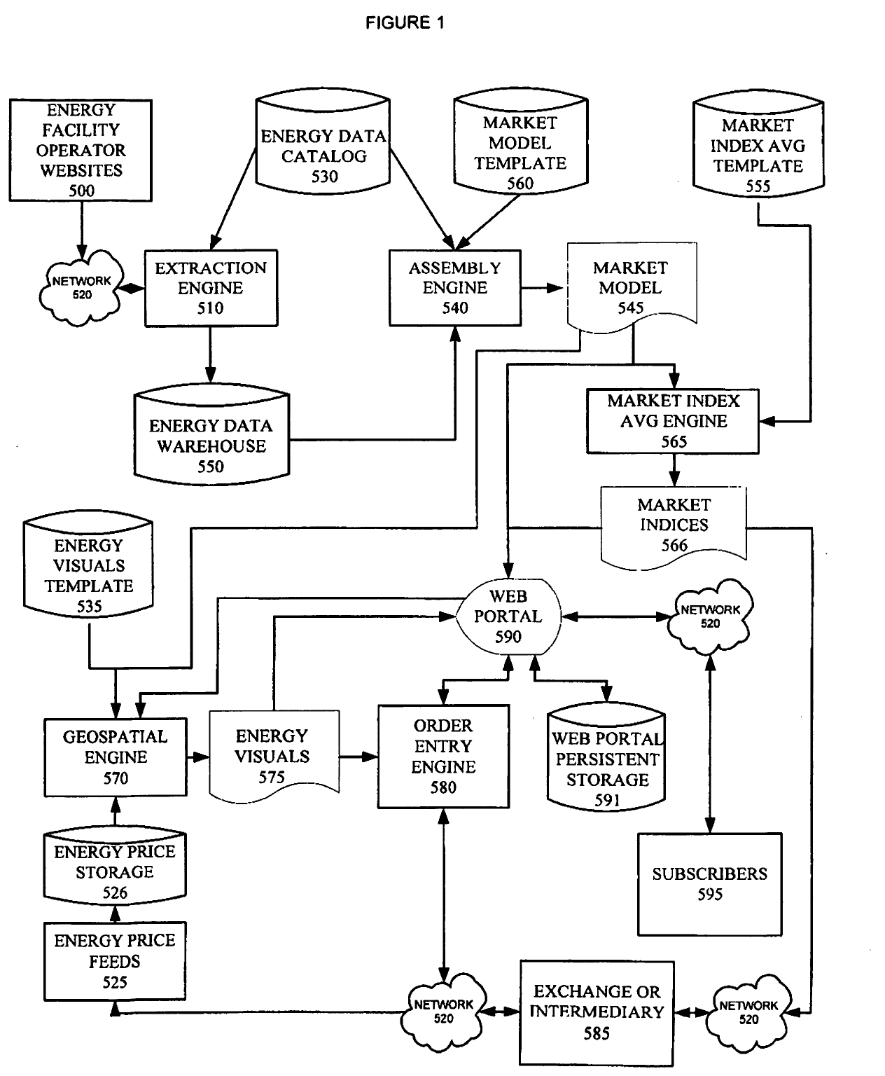

Referring first to FIG. 1, depicted is an illustration of a system operating in accordance with the preferred embodiment of the present invention. Extraction engine 510 utilizes various processes or web-bots to periodically access energy facility operator websites 500 through network 520 for the purpose of gathering “raw” energy fundamentals data.

In the preferred embodiment of the present invention, extraction engine 510 executes on one or more servers or computers, and includes a processor, randomly addressable memory, network interface, local or networked hard disk memory, and input/output interface.

Extraction engine 510 can access energy facility operator websites 500 at various times of the day and it is contemplated that extraction engine 510 can access energy facility operator websites 500 continuously in order to provide real-time analysis. In the preferred embodiment of the present invention, energy facility operator websites 500 belong to various energy market operators including but not limited to natural gas pipelines, independent system electric power operators, regional electric power transmission organizations, state agencies responsible for oil and gas production, US Army Corp of Engineers hydrogenation monitoring sites, etc. It is contemplated that energy facility operator websites 500 can comprise any number of websites. While accessing energy facility operator websites 500, extraction engine 510 extracts and aggregates relevant data from each website. Such relevant data can include current energy flow information, energy production information, transportation/transmission capacity information and other information relevant to the supply, demand and flow of energy.

Extraction engine 510 retrieves information regarding energy facility operator websites 500, including information regarding the location of information, validation of the information, and standardization of the information from energy data catalog 530.

Energy data catalog 530 provides the structure, organization and arrangement of energy flow data. More specifically, energy data catalog 530 contains information utilized to organize and structure Market Model 545, including information associated with measurement point location (e.g., state, county, region, utility), facility type (e.g., interconnect, power plant, processing plant, LNG terminal, storage location, electric utility, gathering company, etc.), connecting party (name of the connecting facility), point type (e.g., production, demand, etc.), energy type (e.g., natural gas, crude oil production, etc.), what producing basin it is associated with (if associated with oil or natural gas production), if it is connected to a power plant, industrial facility or local distribution company, and many other indicators of each measurement point's energy market function. The preferred embodiment of the present invention contemplates information-based tools for using energy data catalog 530 to aggregate energy flow data into meaningful information about the energy marketplace.

Once extraction engine 510 extracts and processes the information retrieved from energy facility operator websites 500, the processed information is transmitted to energy data warehouse 550. It is contemplated that energy data warehouse 550 can comprise any contemporaneously known device that can execute storage and/or processing functions.

Energy data warehouse 550 is a repository of the information extracted and processed by extraction engine 510. In the preferred embodiment energy data warehouse 550 is a database that comprises years of compiled history for each measurement point. Information describing new measurement points is added to the energy data catalog 530. Further, energy data warehouse 550 preferably includes one record corresponding to each measurement point for each measurement period.

A measurement point is typically a reference point for which an energy facility operator provides information concerning energy flow and capacity. A measurement point can be a physical location (e.g., natural gas processing facility, electric power plant). Alternatively, measurement points can be meters on gas mainline transportation systems which record receipt or delivery information. Measurement points can also comprise energy storage locations or portions of a transmission system (e.g., segments of a natural gas pipeline). Measurement points generally comprise a variety of attributes significant to the interpretation of developments in the energy market, including but not limited to (a) flow quantity at such measurement point within a specific timeframe, (b) capacity at such measurement point, (c) facility connected at such measurement point, and (d) physical location of the measurement point. It should be noted that a measurement point need not comprise a physical location. Simply put, a measurement point must be uniquely identifiable and be associated with organized, reoccurring data that describes energy flow activities.

Measurement periods are a function of the energy market data available at each of the various measurement points. For example, a measurement point comprising a segment of a natural gas pipeline may provide two to four measurement periods each day. In contrast, a measurement point comprising an Independent System Operator site for electric power markets may provide a measurement period every five minutes.

Still referring to FIG. 1, assembly engine 540 is responsible for creating Market Model 545 (described in greater detail below) utilizing a three step process.

First, assembly engine 540 accesses information contained within Market Model Template Definition Modules 560 to determine which measurement points are required to generate Market Model 545 and determines how such measurement points should be processed (i.e., mathematically combined, formatted, and grouped).

Next, assembly engine 540 accesses energy data catalog 530 in order to retrieve information explaining how to interpret the data for each measurement point. As described in greater detail above, energy data catalog 530 contains information regarding the particulars of each measurement point.

Finally, assembly engine 540 extracts flow data and other related information from energy data warehouse 550 for the identified measurement points, processes the data to create Market Model 545, and transmits the completed Market Model 545 to web portal 590 for transmission to subscribers 595. Depending on each subscriber's preference, the information can be delivered in a variety of formats, including but not limited to via data network, website, email, or paper-based transmission. In the preferred embodiment of the present invention, Market Model 545 is stored in database format for use by Geospatial Engine 570, Market Index Average Engine 565, and Order Entry Engine 580.

Geospatial Engine 570 displays select information from Market Model 545 in geospatial format, depicting the physical or logical connections between measuring points in Market Model 545 based on specifications contained in Energy Visuals Templates 535.

Geospatial Engine 570 also adds relevant energy market information to the graphical display in order to allow subscribers 595 to visually integrate energy fundamentals and pricing data on a real-time basis. Information added by Geospatial Engine 570 to create such Energy Visuals 575 can include but is not limited to: market price, trade data, and other relevant information retrieved from Price Data Feeds 525. Geospatial Engine 570 compiles information from Market Model 545 and Price Data Feed 525 resulting in an intuitive, map-based format based on specifications contained in Energy Visuals Templates 535. Geospatial Engine 570 transmits completed Energy Visuals 575 to Web Portal 590 for delivery to subscribers 595. In this way, subscribers 595 can view Energy Visuals 575 to visually integrate energy fundamentals and pricing data on a real-time or near real-time basis.

Price Data Feed 525 is generally available data provided by one or more Energy Trading Exchanges or Intermediaries 585. Specifically, Price Data Feed 525 can comprise one or more free or “for-fee” data streams available from various sources of pricing information

Further, Market Index Average Engine 565 combines information contained within Market Model 545 with definitional data from Market Index Average Templates 555 to create a Hub Flow Index (part of Market Indices 566). The Hub Flow Index indicates the composite interaction of production, transportation, storage and demand activities of all market participants across an energy hub.

In the preferred embodiment of the present invention, the Hub Flow Index (part of Market Indices 566) serves as the settlement mechanism for tradable instruments which can be used by energy risk managers to identify and hedge against risks associated with the energy industry. That is, a Hub Flow Index can be computed and published for any hub selected by utilizing known techniques in the art such as those described above.

Order Entry Engine 580 provides a mechanism by which Energy Visuals 575 can be utilized by energy risk managers to enter trades on one or more energy Exchange or Intermediary electronic trading platforms. As described above, Energy Visuals 575 contain energy market information (e.g., pricing and energy flow data information). The preferred embodiment of the present invention allows subscribers 595 to actuate this information (e.g., using a keyboard, mouse, touchscreen or other input device) to retrieve a transaction panel allowing subscribers 595 to buy or sell energy-related financial products.

For example, actuating a graphical element representing a specific hub from Energy Visuals 575 allows subscribers 595 to enter a trade order for the purchase or sale of the related energy derivative, commodity or other instrument based on a trading grid displayed to subscribers 595. Order Entry Engine 580 then transmits the trade order to a selected Exchange or Intermediary 585 for execution of the trade order. In this way, subscribers 595 interested in hedging and trading strategies can implement such strategies as a function of the market fundamentals data presented to them visually.

Market Model 545 is a mathematical representation of physical energy market activities. Market Model 545 provides value to participants in energy markets by revealing information about energy flows in those markets by structuring and summarizing energy flow data. In the preferred embodiment Market Model 545 is a database table structured in such a way to depict market determining factors (e.g., components of energy production/supply, transportation/transmission/distribution and demand/delivery). In alternative embodiments, Market Model 545 can be any organized collection of the information, including but not limited to a spreadsheet document or comma separated value file.

Examples of preferred embodiments of Market Model 545 follow:

Energy Market Fundamentals Gas Market Flow Models are organized by region and pipeline. Energy Market Fundamentals Gas Market Flow Models provide an overview of the gas flow trends across broad areas of North America and provide the ability to drill down on a pipeline-by-pipeline basis to view major production points, interconnect receipts and deliveries, throughput points, compressor volumes, and storage injections/withdrawals.

Energy Market Fundamentals Gas Market Demand Models are organized by region and state. Energy Market Fundamentals Gas Market Demand Models provide details on deliveries to each major utility, power plant and end-use facility with direct interstate pipeline connections. Similar to Energy Market Fundamentals Gas Market Flow Models, regional summaries capture the macro level trends.

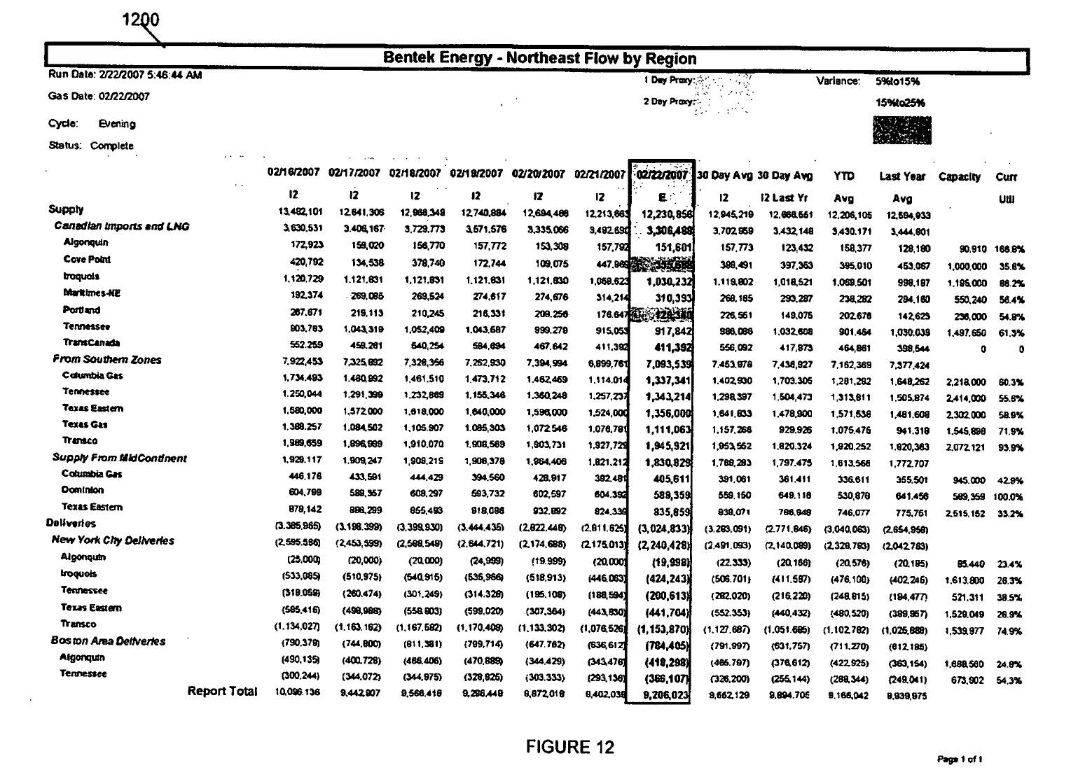

Energy Market Fundamentals Gas Market Supply Models 1200 (depicted in FIG. 12) are organized by producing region and producing basin. Each Energy Market Fundamentals Gas Market Supply Model includes all gas scheduled on each pipeline moving gas from each producing basin and details the source of supply by gas plant, gathering system, etc.

Energy Market Fundamentals Gas Market Import/Export Models include U.S. imports and exports from/to Canada, U.S. exports to Mexico and U.S. LNG imports. Each import/export point and import terminal is detailed and summarized to reveal macro-level trends.

Energy Market Fundamentals Gas Market Storage Models include the Daily Injection/Withdrawal Summary, and facility-by-facility detail for the Eastern, Producing and Western Regions.

In the preferred embodiment, Market Model 545 is filtered in order to eliminate anomalies. One example of such a filtered Market Model 545 involves nine different natural gas pipeline systems having twenty four measurement points located in Illinois and six measurement points located in Indiana. Assembly Engine 540 preferably obtains the measurement point level flow data to create Market Model 545 and then applies one or more data filters to those volume flows to ensure that the data is accurate.

That is, if a particular measurement point has recorded historical gas flows on the order of magnitude of 100 and 200 for the previous 12 months, a report of 2,000 would be identified as potentially unreliable data in an error notification report.

Once all data is verified, Assembly Engine 540 can fill in certain data for intermittent postings. For example, if three measurement points are utilized to compute volume for Market Model 545, and only two of those measurement points provide data seven days per week, then assembly engine 540 of the present invention can approximate and/or extrapolate the missing data for the third measurement point.

The approximation/extrapolation methodology of the present invention will accommodate various conditions such as missing data, data errors, and intermittent data postings. The present invention also contemplates a process for removing measurement points if the system determines that such measurement points are no longer relevant. Likewise, new measurement points can be added to the system of the present invention manually or automatically.

The preferred embodiment of the present invention provides a mechanism for the selection, structure and formatting of measurement points to be included in Market Model 545. This mechanism is contained within Market Model Templates 560.

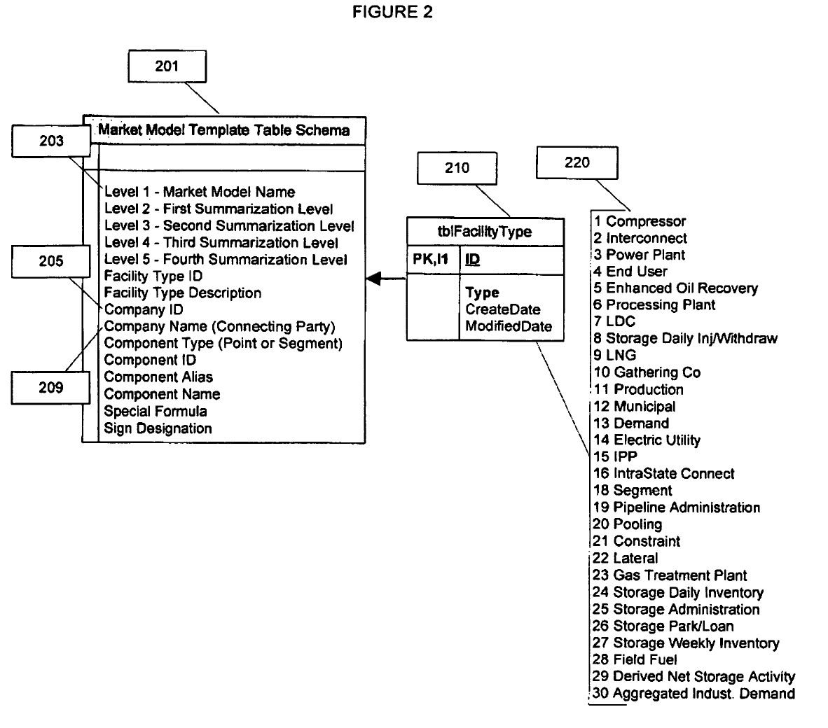

More specifically, Market Model Templates 560 are database tables containing instructions for the selection, structure and formatting of Market Models 545. These instructions determine the methodology allowing assembly engine 540 to create Market Model 545 from measurement point data contained in Energy Data Catalog 530. In the preferred embodiment, Market Model Templates 560 exist that correspond to each Market Model 545 that is to be created. Each row in Market Model Templates 560 therefore corresponds to a unique measurement point from Energy Data Catalog 530 and indicates the methodology for how such measurement point is to be deployed to create each Market Model 545. The instructions for the selection, structure and formatting of Market Models 545 are contained within Market Model Template Table Schema 201 as depicted in FIG. 2.

Referring now to FIG. 2, shown is an illustration of Market Model Template Table Schema 201 indicating various types of information required to construct Market Model 545. In the preferred embodiment of the present invention, five “Aggregation Levels” are provided for Market Models. However, it is contemplated that any number of Aggregation Levels may be used. The purpose and use of Aggregation Levels is to provide a hierarchal structure of data to be utilized in Market Model Template Schema 201. That is, Aggregation Level 2 contains data that comprises a subset of the total data contained within Aggregation Level 1. In turn, Aggregation Level 3 comprises a subset of the total data contained within Aggregation Level 2. In this way, the present invention can sort information in order to create specific reports based on narrowing data classification embodied by the Aggregation Levels. This concept is explained further below.

Still referring to FIG. 2, the first column in the table is Level 1 203. This is the first Aggregation Level, and contains the name of Market Model 545. The second through fifth columns indicate subsequent Aggregation Levels for the specific measurement points to be used in Market Model 545. All measurement points having an identical Aggregation Level are combined for presentation in Market Model 545.

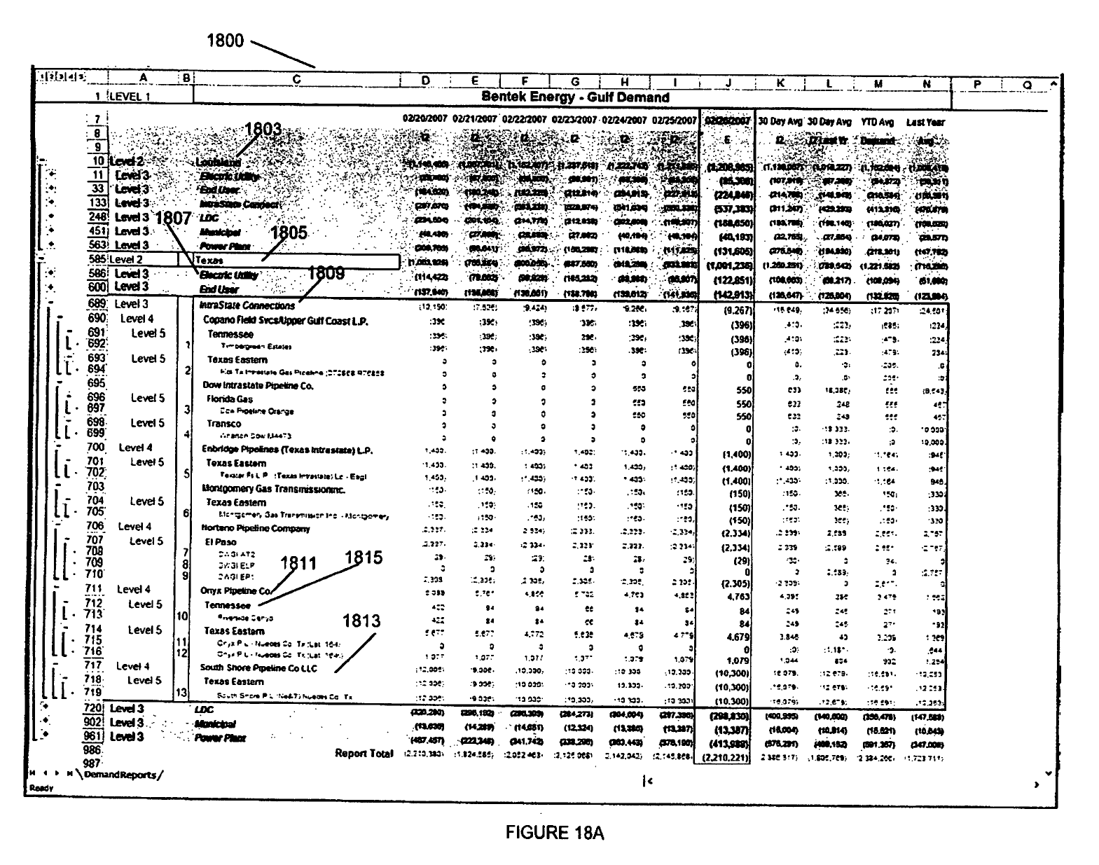

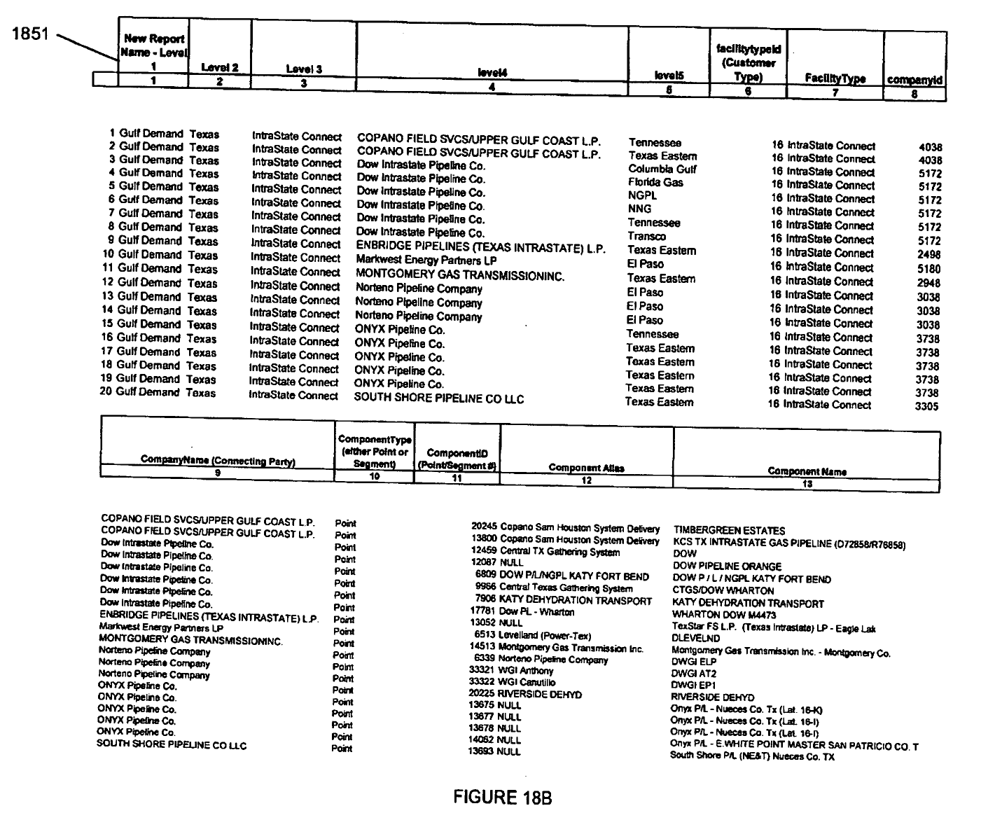

As an example of Aggregation Levels of Market Model 545, Natural Gas Gulf Demand Market Model 1800, depicted in FIG. 18A, contains various Aggregation Level 2 categories, including Louisiana 1803 and Texas 1805. Aggregation Level 3 categories that are a subset of Texas 1805 include Electric Utility 1807 and Intrastate Connections 1809. Similarly, depicted are Aggregation Level 4 categories as a subset of Intrastate Connections 1809, including Onyx Pipeline Co. 1811 and South Shore Pipeline Co LLC 1813. Finally, depicted in FIG. 18A are Aggregation Level 5 categories as a subset of Onyx Pipeline Co. 1811, including Tennessee 1815. Therefore, Natural Gas Gulf Demand Market Model 1800 is created using twenty measurement points, listing to thirteen data rows (all points with flow data for the period selected).

Referring now to FIG. 18B, depicted is Natural Gas Gulf Demand Market Model Template Table Schema 1851 which contains all of the information utilized to create Natural Gas Gulf Demand Market Model 1800 as well as the additional information required to create hundreds of Market Models 545. The preferred embodiment of the present invention allows for the manipulation of the data contained in Market Model Template Table Schema 1851 to create hundreds of Market Models 545.

Referring now to FIG. 2, Facility Type field 210 is populated with a single Facility Type ID and name. The Facility Type ID and name are generally selected from Facility Type List 220. It is contemplated that various Facility Types may be added to the Facility Type List 220 as is required to identify new facilities.

Examples of other columns contained within Market Model Template Table Schema 201 are Company ID 205 and Company Name 209. Each of said Company ID and Company Name fields contains a unique identifier and name for the company that owns the facility at the measurement point. Other examples are: Component Type which contains a reference to whether data refers to a single measurement point or a measurement point grouping (sometimes called a “segment”); Component Name and Component ID which contain a unique identifier for the measurement point referenced by that row; Component Alias which contains the name to be used in Market Model 545 when displaying the data associated with the measurement point, special formula containing a mathematical formula that is to be applied to flow data at the measurement point as Market Model 545 is computed; and Sign Designation which contains a code that indicates if the sign of the flow data should be reversed.

The preferred embodiment of the present invention provides for a mechanism and procedure for the design and creation of Market Model Templates 560. More specifically, the present invention contemplates that Market Model Templates 560 can be created for any aspect of an energy market where measurement point data is available in Energy Data Warehouse 550 and information regarding the measurement point data is available in Energy Data Catalog 530.

The five steps utilized in the design and creation of Market Model Templates 560 are described below.

First, a geographically delineated energy market must be defined. Market Model Templates 560 are preferably created to visualize one or more of the three key aspects of energy flows: (a) supply, (b) transportation/transmission, and/or (c) demand. That is, Market Model Templates 560 are typically focused on a particular geographic region recognized by energy market participants to function as a contiguous marketplace. Information regarding accepted geographic bounds of energy markets can be obtained from a variety of sources, including Energy Information Agency (EIA) reports, energy trade publications (e.g., Megawatt Daily, Oil Daily, Natural Gas Intelligence, ICE Data, Oil Price Information Service) and energy market participants themselves. The present invention also contemplates creation of Market Model Templates 560 for other relevant sectors of an energy market, such as imports/exports and storage inventories.

Next, the energy market to be modeled is diagrammed or modeled. Each geographically delineated energy market as defined in the first step is a transportation/transmission network connecting measurement points describing supply, demand, storage and other aspects of an energy network. To create Market Model 545, each of these measurement points is identified, and each transportation/transmission route connecting measurement points must be specified.

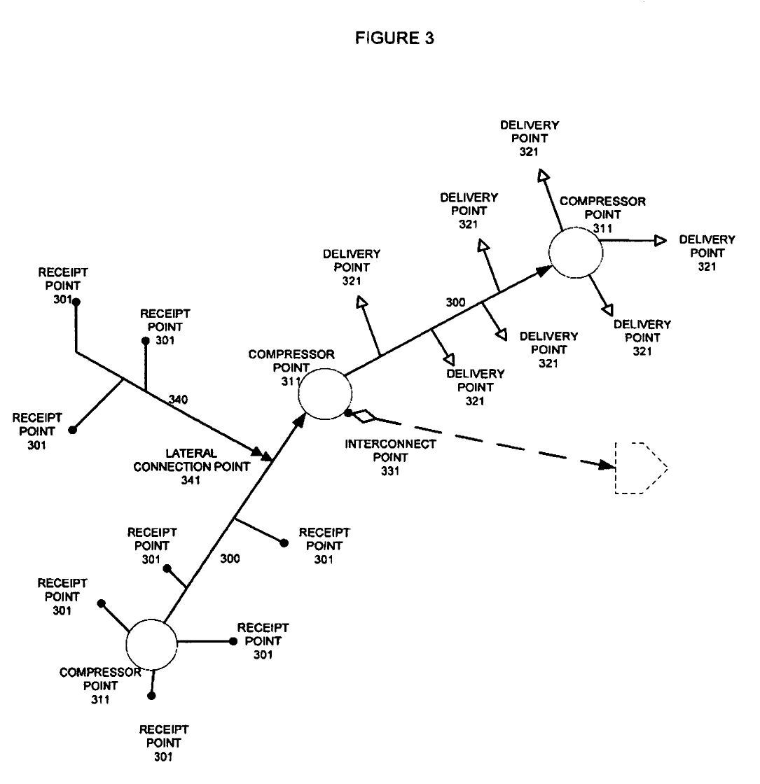

Referring now to FIG. 3, shown is an illustration of representative energy network, in this case a natural gas pipeline system. Similar graphical representations can be created for power grids, crude oil shipping routes and other energy transportation networks. Information required to create such graphical representations of energy networks is generally available from operators of energy transportation and transmission systems.

Still referring to FIG. 3, the natural gas pipeline system depicts several Receipt Points 301 which typically represent one or more natural gas wells located in gas producing regions or fields. Receipt Points 301 are responsible for delivering natural gas into the pipeline system. In addition, some of Receipt Points 301 are directly connected to Compressor Points 311 which are pumping facilities that propel the natural gas through the pipeline system. Certain of Receipt Points 301 may be connected to branches of the pipeline system known as Laterals 340 and connected into the Mainline Pipeline 300 at Lateral Connection Points 341. Delivery Points 321 are locations where natural gas is delivered (e.g., industrial facilities, power plants, local distribution companies (gas utilities), municipals (cities), etc.). Interconnect Points 331 connect one pipeline system to another.

The third step in the design and creation of Market Model Templates 560 is to enumerate and catalog the information related to each measurement point. In accordance with the preferred embodiment of the present invention, the information associated with measurement points is enumerated and cataloged using the data structure contained in Energy Data Catalog 530 as described above with respect to FIG. 1. Each measurement point is preferably enumerated using a standard numbering system applicable to all aspects of the energy market to be modeled. This eliminates any disadvantage associated with proprietary numbering systems used by the operator or owner of each measurement point in the energy market being modeled. Therefore, each measurement point is preferably cataloged using the taxonomy contained within metadata from Energy Data Catalog 530 for information such as function of the measurement point in the Energy Market network. For example, delivery/receipt, facility type (e.g., interconnect, power plant, processing plant, LNG terminal, storage location, electric utility, gathering company), connecting party (name of the connecting facility), measurement point location (e.g., state, county, region, utility), etc.

Next, it is important to describe the energy flow relationships between the measurement points. Using the illustration or diagram of the energy market to be modeled (e.g., FIG. 3), the relationships between measurement points is structurally described such that energy flows across and through the market can be represented. In accordance with the preferred embodiment of the present invention, this is accomplished by creating a hierarchical structure for the energy market represented by Aggregation Levels as referenced above in the section covering Market Model Template Structure, then assigning each measurement point to one of the nodes in the lowest Aggregation Level of that Market Model.

The hierarchical structure employed is selected to reveal the behavior of energy flows within the energy market to be modeled by subdividing the market into functional components where possible. Functional components can include supply, demand, storage, throughput and other aspects of energy flows.

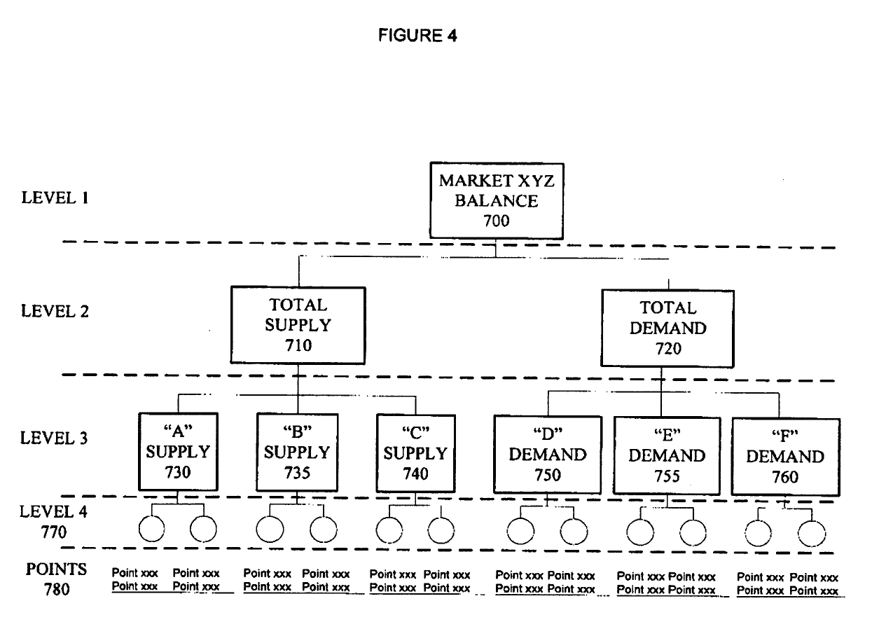

One such hierarchical structure is the Market Balance Aggregation, exemplified in FIG. 4. The Market Balance Aggregation can be used to depict energy flow relationships within a natural gas market containing three supply or producing region pipelines “A” Supply 730, “B” Supply 735, and “C” Supply 740, and three demand or consumption region pipelines “D”: Demand 750, “E” Demand 755, and “F” Demand 760. In this example, Level 3 in Market Model Template 560 structure was used as the Aggregation Level for pipeline level data.

It should be noted that each of the three supply and three demand region pipelines depicted in FIG. 4 could be owned by different corporate owners and use different systems and taxonomies to provide data on natural gas flows and capacities. Using the first three steps discussed above, the present invention standardizes and structures the data from these systems in order to combine it in a Market Model with functional components representing supply and demand.

Still referring to FIG. 4, Level 4 770 represents a lower Aggregation level comprising segments or zones on each of the various pipeline systems. In this example, each pipeline system is depicted as having two zones. Level 5 780 represents the measurement points included in each of the pipeline zones.

With respect to upper Aggregation Levels, Level 2 represents the total of Supply 710 and Demand 720 for each of the pipelines in the market. In turn, Level 1 represents the net of Supply and Demand for all pipelines in the market, also known as Market Balance 700 for the market depicted.

Each of the Level 5 Points 780 depicted in this Market Model is assigned to one of several nodes in a higher level of aggregation, in this case Level 4 770. In this way, energy flows can be tracked by zone, pipeline, up through total supply or demand to indicate the total energy balance in that market.

In addition to the Market Balance Aggregation, other hierarchical structures may be used to depict other aspects of energy flows within a market. For example, hierarchical structures can reflect storage injections and withdrawals, flow constraints at the intersection of multiple transportation/transmission systems, and imports/exports of energy at cross-border and port locations.

The final step in the design and creation of Market Model Templates 560 is coding the Market Model Template Structure. Once all measurement points in the delineated energy market have been assigned within a hierarchical structure, Market Model Templates 560 can be coded within the Market Model Template Structure as described above. This process consists of the population of a database table configured in the manner depicted in FIG. 2.

Referring again to FIG. 1, Geospatial Engine 570 combines energy flow and capacity information from one or more Market Models 545 and other market information such as market prices and trading volumes from Price Data Feeds 525 provided by one or more Energy Trading Exchanges or Intermediaries 585 in order to create Energy Visuals 575. By combining flow and pricing data in a map-based presentation format, subscribers 595 gain the ability to visually integrate energy fundamentals and pricing data on a real-time basis.

In the preferred embodiment of the present invention, Geospatial Engine 570 uses data from Energy Visuals Templates 535, Market Models 545 and Energy Price Feeds 525 to create Energy Visuals 575. Energy Visuals 575, an example of which is called a “Hub Flow Map,” are graphical representations depicting the physical or logical connections between measurement points in a Market Model, and the dynamic flows of energy between the different elements of one or more Market Models.

The specifications for Energy Visual 575 are contained within Energy Visual Templates 535. Subscribers 595 utilize Web Portal 590 to select Energy Visual 575 and to select the date or date range to be used in the assembly of various Energy Visuals 575. Once selected, Energy Visuals 575 are provided to subscribers 595 via web portal 590.

Energy Visuals Templates 535 are preferably created with respect to specific geographic areas in order to include individual hubs or groups of hubs that are recognized by energy market participants to function as energy markets. Information regarding accepted geographic bounds of energy markets can be obtained from a variety of sources, including Energy Information Agency (EIA) reports, energy trade publications (such as Megawatt Daily, Oil Daily, Natural Gas Intelligence, ICE Data, Oil Price Information Service) and energy market participants themselves.

Examples of Energy Visuals 575 include:

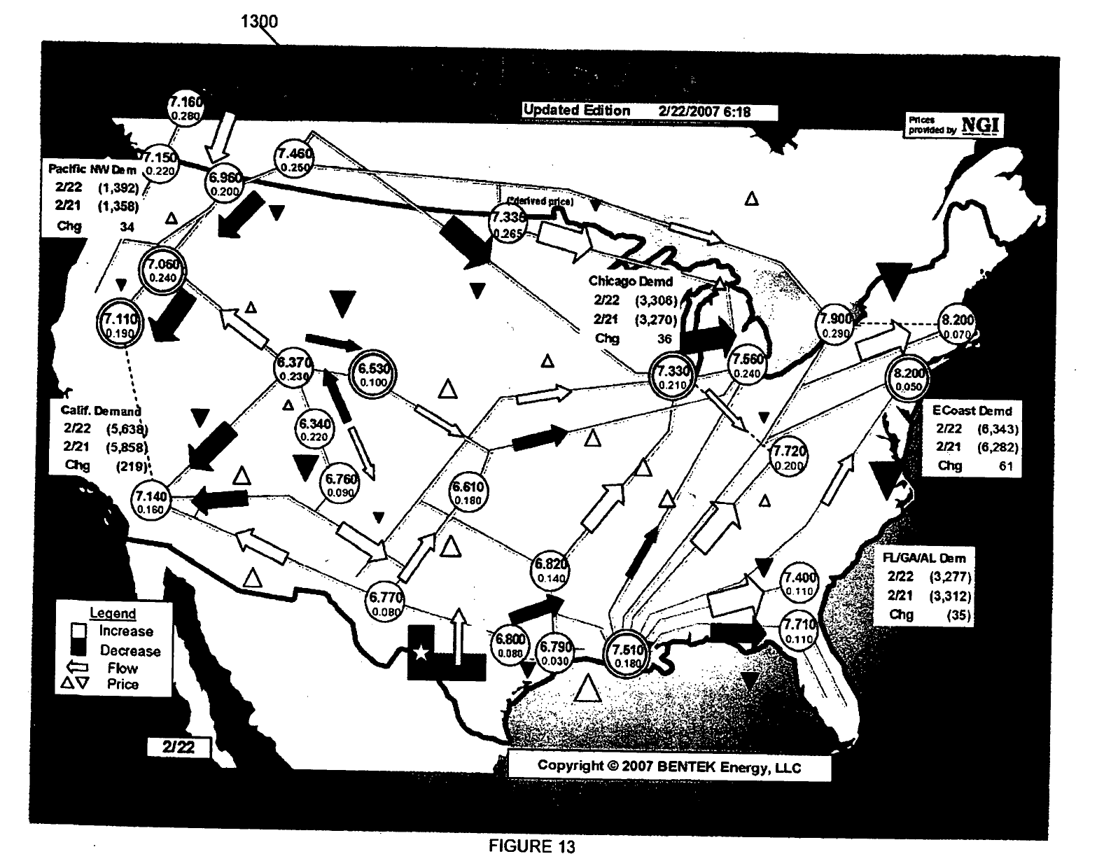

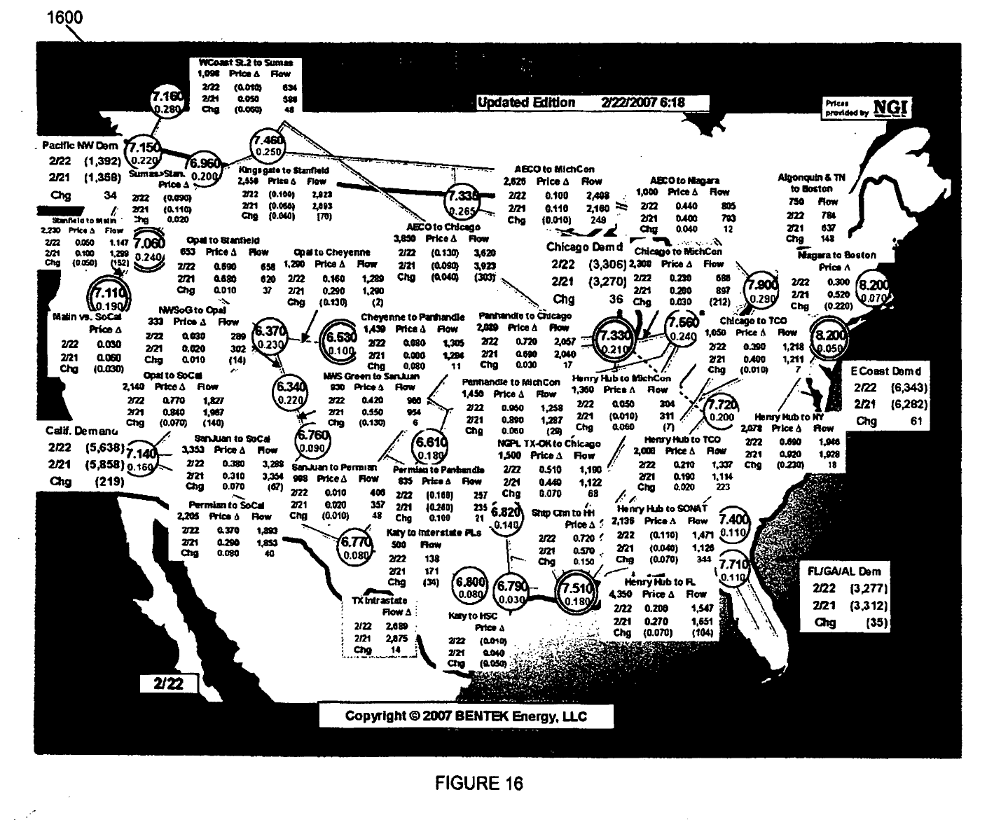

North America Natural Gas Hub Flow Map 1300 (shown in FIG. 13) depicts the changes in natural gas flow between each of the major natural gas hubs on the most significant North America natural gas pipeline corridors. North America Hub Flow Map 1300 incorporates information depicting changes in prices at each of the major natural gas hubs. Pipeline flows and price data are extracted from Market Models and summarized into meaningful geographical components. This data is then graphically rendered in a manner that reveals the relationship between flows and prices across North America. In the preferred embodiment, the direction of gas flows is indicated by arrows which change in size depending on the change in the magnitude of flow from one day to the next—the larger the change, the larger the arrow. In the preferred embodiment, increases in flow are shown in green while decreases are shown in red. In this way, relative changes in the market are reflected visually. Similarly, changes in price differentials between hub locations are shown by triangles—the larger the change, the larger the triangle. Increases point up and are shown in different colors, fonts or other distinguishing characteristics than decreases, which point down. Referring to FIG. 16, North America Hub Flow Map 1600 also includes a numerical table reference page that provides the values used to generate all graphical components of North America Natural Gas Hub Flow Map 1300 (shown in FIG. 13).

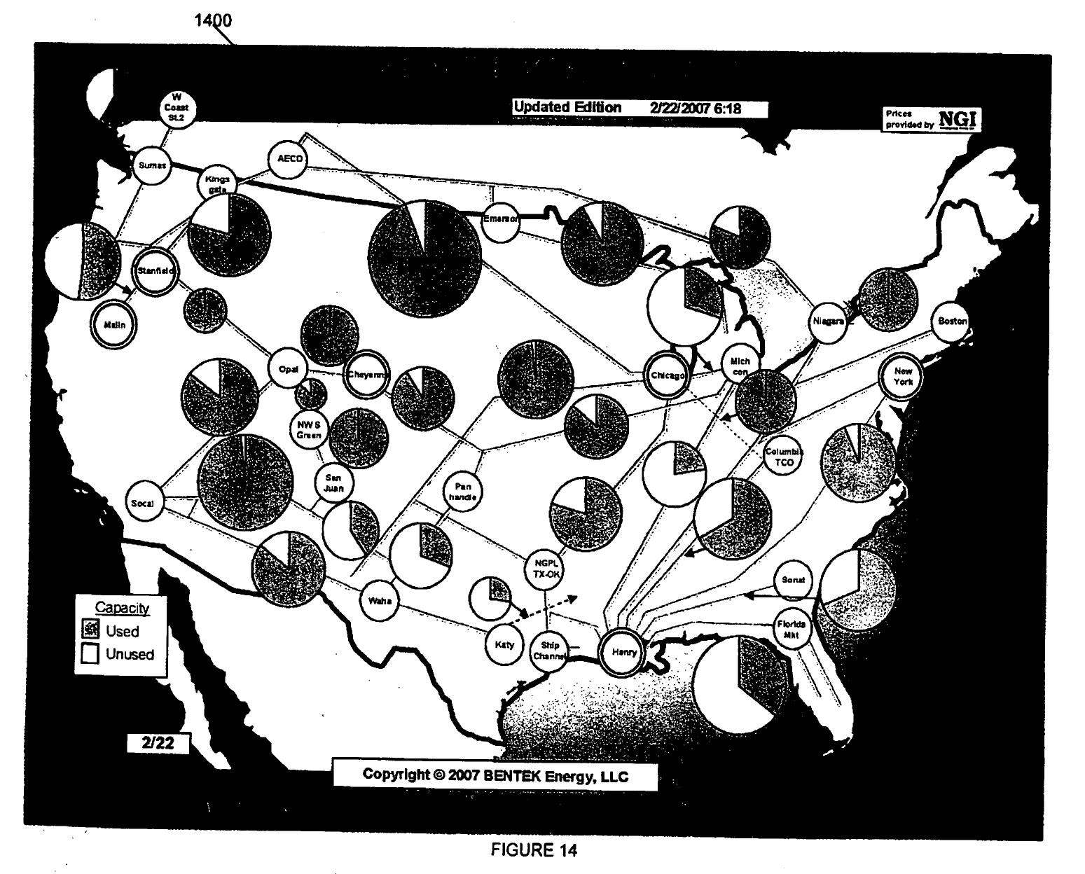

North America Natural Gas Hub Pipeline Capacity Map 1400 (shown in FIG. 14) depicts the capacity utilization along the major natural gas pipeline corridors in North America. In the preferred embodiment, the relative capacity along each corridor is shown as a relatively sized pie chart, and the utilization of that capacity as show by a “slice” within that pie chart.

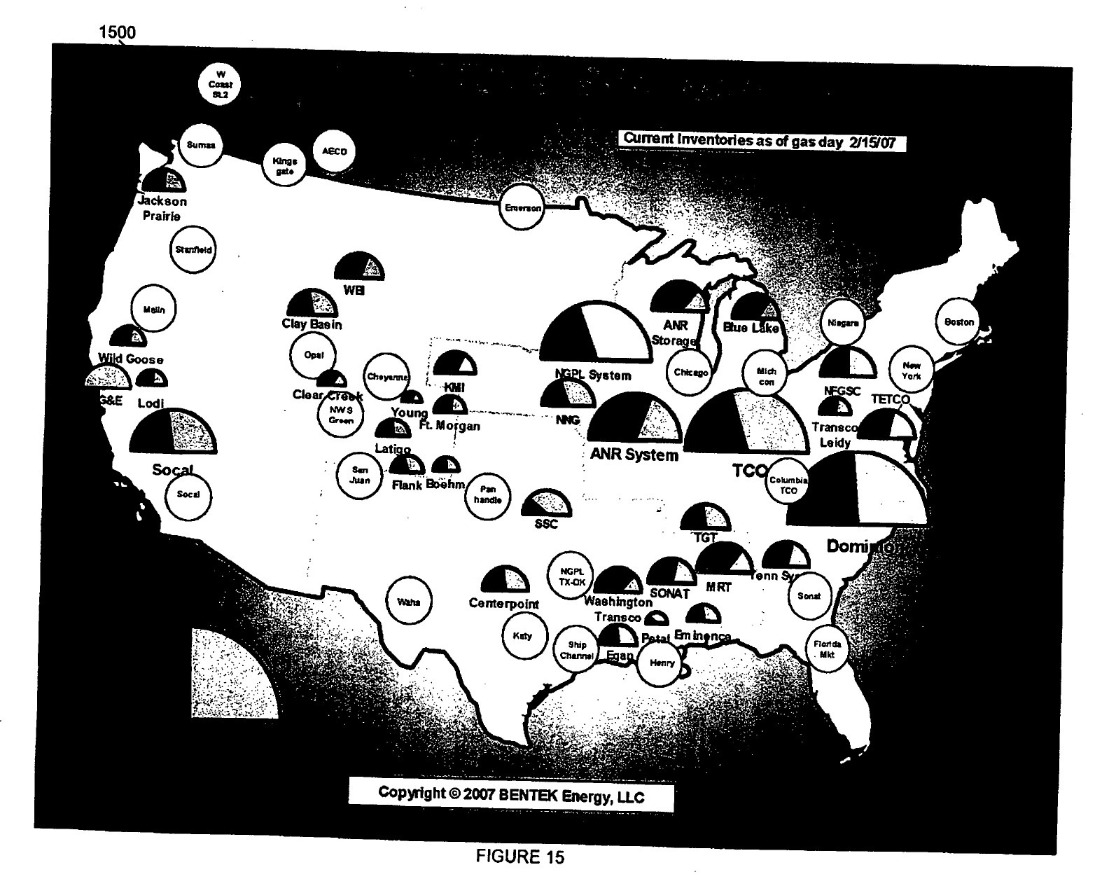

North America Natural Gas Storage Capacity Map 1500 (shown in FIG. 15) depicts the capacity utilization of certain natural gas storage facilities in North Selected. In a preferred embodiment, the relative capacity in each major facility or facility group is shown by a half circle “gauge” chart, and the utilization of that capacity as show by a “slice” within that gauge chart (red indicating utilized capacity, green indicating unutilized capacity).

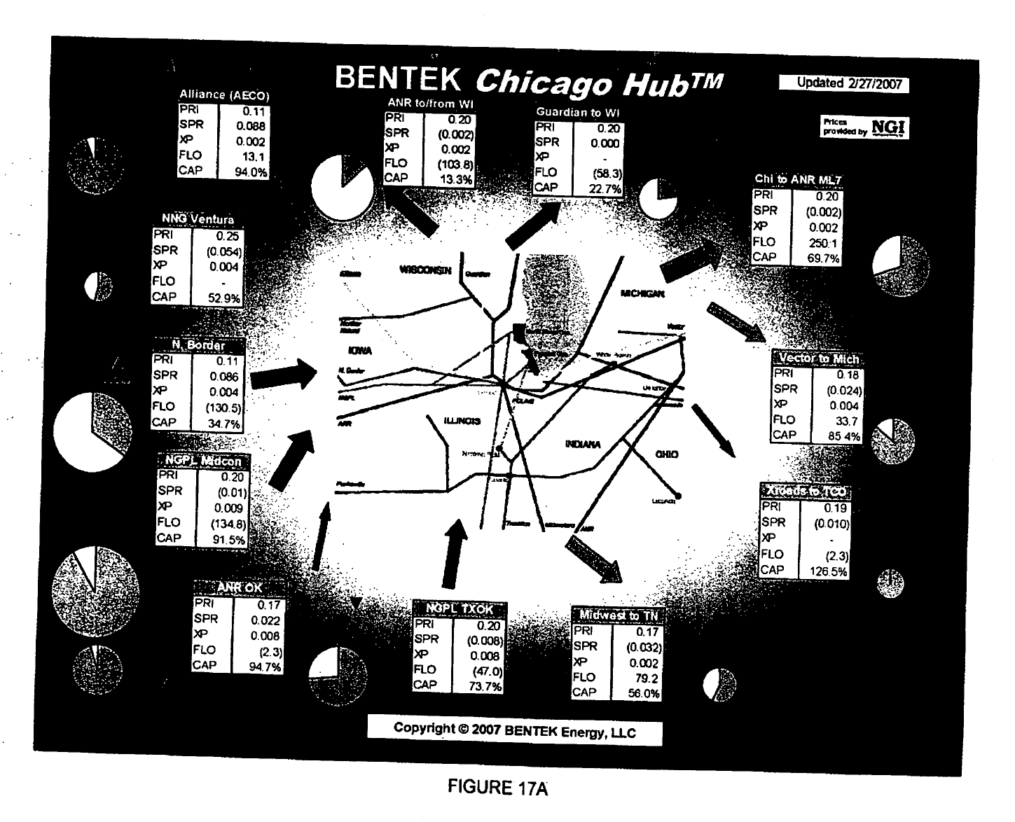

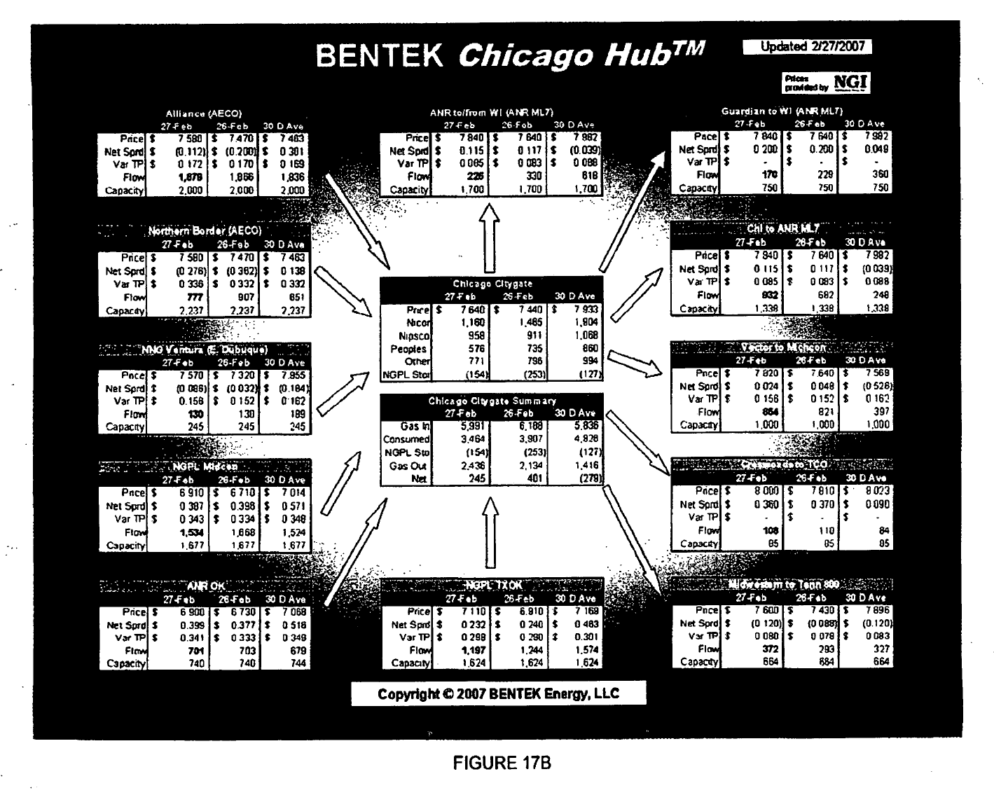

Regional Natural Gas Hub Detail Maps (an example of which is depicted in FIGS. 17A-B) depict natural gas flows, capacities and pricing for specific regional natural gas trading hubs. Each Hub Detail Map includes pipelines delivering gas into the hub and taking gas away from the hub, showing receipt volumes, pipeline capacities into and out of the hub, incremental transportation costs from/to sources of supply and markets, and prices at the hub and for sources of supply and markets. FIG. 17A depicts an example of Regional Natural Gas Hub Detail Maps, specifically Chicago Regional Natural Gas Hub Detail Map 1700, but Regional Natural Gas Hub Detail Maps can exist for any selected region, including: Henry (LA), New York, Pacific Northwest, Pacific Gas & Electric, Cheyenne and ANR pipeline. Each Regional Natural Gas Hub Detail Map includes a numerical table reference page that provides the values used to generate all graphical components. With respect to the example shown in FIG. 17A, corresponding numerical table Chicago Regional Numerical Table 1705 is depicted in FIG. 17B.

The method of the present invention further provides a mechanism for the selection, structure and formatting of information to be included in Energy Visual 575 as depicted in FIG. 1. This mechanism is contained within Energy Visuals Templates 535.

Each Energy Visuals Template 535 is composed of three basic components: (a) a Base Map indicating the major energy flow corridors for the energy market to be mapped, (b) dynamic graphical elements used to depict certain aspects of energy flows, capacities, prices, etc., and (c) a SQL database table containing instructions for the combination of the basic components to create an Energy Visuals, called the Energy Visuals Template Table. The instructions contained in the Energy Visuals Template Table define how aggregated data from Market Models are combined with market prices and trading volumes from Price Data Feeds 525 by the Geospatial Engine 570 to create Energy Visuals 575.

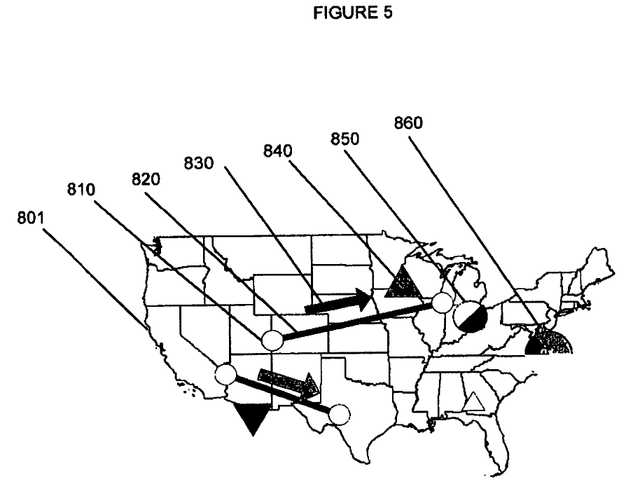

Referring next to FIG. 5, depicted is an illustration of Energy Visual 575. In this example, the Base Map is a map of the United States 801. Superimposed on this map are the location of various Energy Hubs 810 and Energy Flow Corridors 820 which represent major transportation/transmission connections between Energy Hubs 810. Certain Dynamic Graphical Elements are shown in callouts 830, 840, 850 and 860 and are described in greater detail below. These Dynamic Graphical Elements are positioned and scaled by Geospatial Engine 570 based on information in the Energy Visuals Template Table and information from Market Models referenced within the Energy Visuals Template Table.

In the preferred embodiment, Dynamic Graphical Elements shaped like arrows 830 represent the direction of energy flows from one hub to another connected hub along a corridor. The characteristics of arrows 830 represent the change in flow between hubs from one time period to another. Such characteristics can include color (red=down, green=up), shape, etc. The size of arrow 830 relative to other Dynamic Graphical Elements in the Energy Visual represents the magnitude of change from one time period to another (large=large, small=small). Further, Dynamic Graphical Elements shaped like triangles 840 represent the price differential between hubs from one time period to another whereby the direction of the change can be represented by color and orientation (red and down=lower price differential, green and up=higher price differential) and the magnitude of the change by size of the triangle 840 relative to other Dynamic Graphical Elements in the Energy Visual (large=large, small=small). Dynamic Graphical Elements shaped like pie charts 850 represent the transmission/transportation capacity between hubs with the relative magnitude of capacity represented by the size of the pie chart magnitude relative to other Dynamic Graphical Elements in the Energy Visual (large=large, small=small), and the proportion used represented by two “slices” in the pie (one slice capacity used, the other slice capacity available). Dynamic Graphical Elements shaped like half circles 860 represent the storage capacity available at hubs or other locations hubs with the relative magnitude of capacity represented by the size of the gauge chart magnitude relative to other Dynamic Graphical Elements in the Energy Visual (large=large, small=small), and the proportion used represented by two “slices” in the gauge (one slice capacity used, the other slice capacity available). Other Dynamic Graphical Elements may be used and scaled as required.

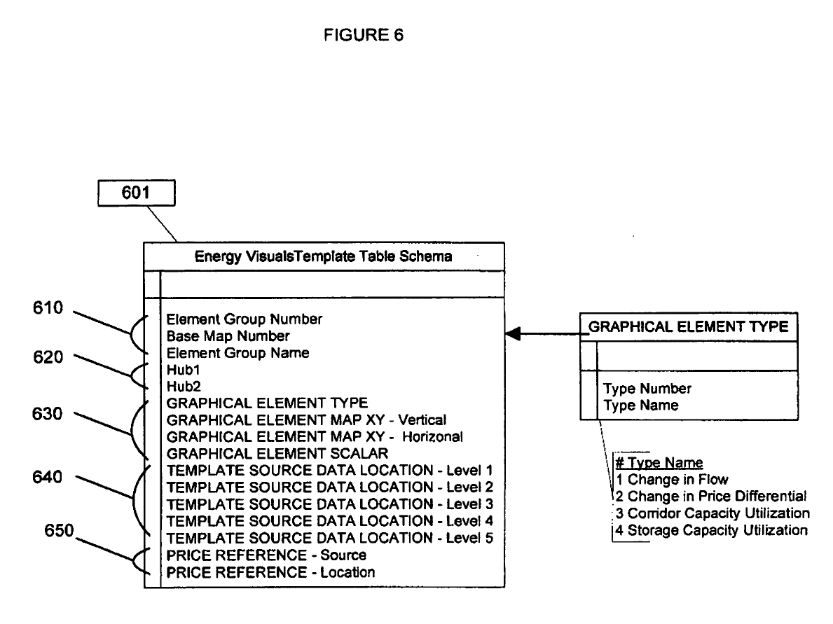

Referring now to FIG. 6, shown is an illustration of Energy Visuals Template Table Schema 601 indicating various types of information required to construct Energy Visual 575. In that table, one row exists corresponding to each Dynamic Graphical Element used to construct each Energy Visual 575.

In the preferred embodiment, five categories of instruction data are contained within Energy Visuals Template Table Schema 601.

First, Identifier 610 identifies each Dynamic Graphical Element with a unique number, links each Dynamic Graphical Element to an Energy Visual Base Map and provides a label or name for each Dynamic Graphical Element.

Next, Name 620 refers to the name of the hub or hubs to which the Dynamic Graphical Element applies.

Further, Type 630 indicates the type of Dynamic Graphical to be created (e.g., flow, price, capacity, etc.), the location on the base map where the Dynamic Graphical is to be placed (horizontal and vertical indices), and a scalar value that indicates to the Geospatial Engine how the Dynamic Graphical Element is to be resized based on source data.

Next, Flow Data 640 indicates the location of flow and/or capacity data used to construct the Dynamic Graphical Element in the appropriate Market Model. The data is referenced in accordance with the relevant Market Model level.

Finally, Pricing Data 650 indicates the location of pricing data used to construct the Dynamic Graphical Element in the appropriate Market Model. The data is extracted from Energy Price Storage 526 by referencing the Source and Location of the pricing data required.

Referring again to FIG. 1, in accordance with the preferred embodiment of the present invention, Geospatial Engine 570 uses Market Model 545 and Energy Price Feeds 525 to create Energy Visuals 575 using the process described below.

First, subscriber 595 utilizes Web Portal 590 to select Energy Visual 575 for creation. Such a selection can occur by searching a database of available Energy Visuals, by selecting from a drop down list of available Energy Visuals, by entering the requested Energy Visual identifier, or by any other means. Subscriber 595 can select the date range for which the Energy Visual 575 will reference. Web Portal 590 communicates this information to Geospatial Engine 570.

With this information, Geospatial Engine 570 accesses Energy Visuals Template storage 535 to obtain Energy Visuals Template 535 for Energy Visual 575 selected by subscriber 595. Based on the date range selected by subscriber 595, Geospatial Engine 570 compiles the data required to assemble Energy Visual 575 from the appropriate Market Model 545 and/or Energy Price Storage 526. Geospatial Engine 570 obtains Market Model data based on information such as that disclosed in FIG. 6, wherein Levels 1-5 in Flow Data 640 correspond exactly to Levels 1-5 in the Market Model Template Schema 201 depicted in FIG. 2. Geospatial Engine 570 obtains price data from Energy Price Storage 536 based on the Pricing Data 650 represented in FIG. 6.

Based on that data, Geospatial Engine 570 retrieves the base map and Dynamic Graphical Elements required to compile and create Energy Visual 575 from Energy Visuals Template storage 535. Geospatial Engine 570 sizes and positions the Dynamic Data Elements specified in the Energy Visuals Template on the Base Map.

Finally, Geospatial Engine 570 transmits the rendered Energy Visual to subscriber 595 via Web Portal 590.

As described above, with the corresponding information in hand, market participants can utilize Energy Visuals 575 as a tool to determine appropriate hedges against market risk, as well as a tool to launch an appropriate trade order entry system. That is, a market participant can view Energy Visuals 575 to visually analyze the changing energy marketplace and actuate a portion of Energy Visuals 575 to launch the order entry system corresponding to that portion of Energy Visuals 575 which was actuated.

An “Energy Market Index” is the distillation of broad range of energy flow statistics into an individual index value. A “Hub Flow Index Average” combines Energy Market Indices in a manner designed to encapsulate a wide variety of dynamic market factors into another tradable index that can be used to hedge a variety of energy industry risks which are otherwise not hedgible with existing market venues and mechanisms.

Energy Market Indices are preferentially designed to reflect market factors in and around energy hubs. As noted above, energy hubs are usually located where there are a significant number of connections between components of an energy transportation/transmission network. Pricing in almost all energy markets is established at energy hubs, with non-hub trading activity based on some transportation/transmission cost differential to a hub-based price.

When an Energy Market Flow Index is created for an energy hub, the value of the Energy Market Flow Index reflects a measure of flow activity at that hub. A high level of flow indicates that significant levels of energy are moving through that hub. Conversely, a low level of flow indicates that minimal levels of energy are moving through that hub. A well selected and designed Energy Market Flow Index can effectively represent the level of energy flow activity across not only an individual hub, but also across a relatively wide area containing several hubs, where energy flows exist to and/or from each hub. In this way, the Energy Market Flow Index acts as an indicator of energy market activities across a broader geographic area.

Furthermore, Energy Market Indices representing several energy hubs can be mathematically combined to create “Hub Flow Index Averages” which can be used to indicate the composite interaction of energy production, transportation, storage and demand activities of all market participants across a broad sector of a geographically delineated energy market.

By observing the value of one or more Hub Flow Index Averages and/or Energy Market Index values on a frequent basis, users (subscribers) can monitor energy market activities much more frequently and effectively than is possible using other techniques and processes.

Furthermore, since a Hub Flow Index Average reflects a broad swath of energy market activity, a Hub Flow Index Average can be used as the settlement mechanism for energy derivatives used by energy market participants to hedge certain energy market risks. For example, business risks that should be managed by participants in the natural gas industry include:

When gas flows are high, distribution companies (e.g., pipelines) achieve higher earnings because the throughput of natural gas increases. Conversely when flows are down, revenues are down.

When capacity is fully utilized, many pipelines and local distribution companies have the right to curtail industrial customers to insure that residential heating demand is satisfied. Therefore, when gas flows are high in the market area, industrial companies are at risk of having their fuel supply curtailed.

As pipeline capacity utilization nears 100%, pipelines are required to prorate (i.e., allocate) that capacity according to certain presubscribed rules. Therefore, when gas flows are high, gas producers are at risk of having their ability to deliver gas to the market prorated. The revenues of gas producers can be severely impacted by such allocations that require that they limit their sales of gas production.

Similar risks are inherent in other energy markets such as electric power, crude oil, coal, or motor gasoline.

Of course, some market participants may not be interested in hedging against risk. The present invention therefore contemplates the use of the disclosed system to take a position in the market for short or long term speculation.

Weather can be one factor that influences the magnitude of energy flows. However, there are many other factors that impact energy flows in addition to weather, including economic activity (factories shutting down or starting up), mechanical problems (compressors out, pipeline explosions, transmission line outages), supply curtailments (due to hurricanes or other natural disasters), new transportation system construction or expansion of existing systems, capacity contracts which constrain deliveries, or even commercial contracts that require specific levels of capacity utilization.

In all of these cases, there is currently no viable hedging tool available to industry participants tied to energy flows which would enable such a hedging program for business risks associated with changes in the flow of energy from producer to end-user. That is, because energy flow does not perfectly correlate with price, current derivative instruments based on energy price are poor mechanisms for hedging against risks associated with flow fluctuation. Therefore, a Hub Flow Index Average can be used by energy industry decision-makers as the settlement basis of derivative instruments that can act as risk management tools for aspects of their business activities which are impacted by changing energy flows.

Hub Flow Index Averages can be used by energy industry decision-makers as risk management tools for aspects of their business activities which are impacted by changing energy flows. This is accomplished by using a Hub Flow Index Average as the settlement mechanism for a financial instrument (derivative instrument) designed to transfer risk between two or more parties.

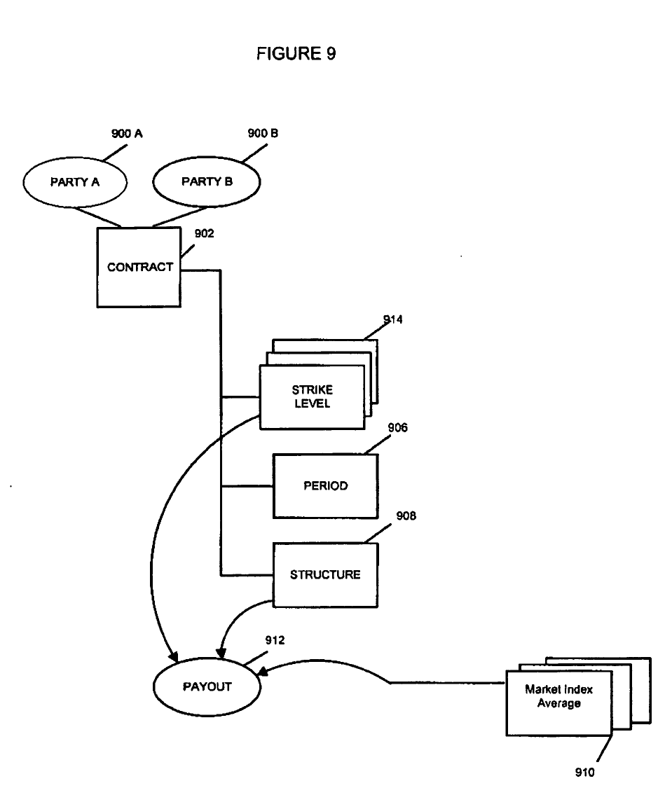

Referring now to FIG. 9, shown is an exemplary derivative instrument in accordance with one aspect of the present invention. A contract 902 is entered into between first party 900A and second party 900B. The present invention contemplates a contract entered into by two or more parties (e.g., 900C, 900D, . . . 900n). Such a contract may be consummated in any known manner, including an electronic trading system. The preferred embodiment of the present invention utilizes electronic order entry systems as described within the disclosure to execute the contract.

Contract 902 has a given structure 908, such as a put or call option, a swap, or a collar. Other derivative instruments vehicles can be utilized including but not limited to insurance contracts. Contract 902 is associated with contract period 906, and is associated with strike levels 914. It should be noted that strike levels 914 can comprise one or more levels. At the termination of contract period 906, Hub Flow Index Average 910 is compared to strike levels 914 and, depending on the contract structure 908, payout 912 between first party 900A and second party 900B may be required.

By way of example, first party 900A is a natural gas local distribution company in Louisiana and purchases gas in and around the Louisiana region for delivery to its customers. During the month of March, first party 900A determines that it is at risk of a shortfall in regional natural gas flows in the month of July, whether due to a hurricane, production curtailments due to threat of a hurricane, mechanical problems with one or more regional gas processing facilities, etc. If flows are reduced then first party 900A may incur a financial loss. First party 900A therefore desires to hedge its business risk of this potential loss.

Continuing the example, second party 900B is a major financial institution in the business of accepting certain business risks for profit. A Hub Flow Index Average for the Louisiana market is available for first party 900A and for second party 900B to transfer this risk. The Hub Flow Index Average for the month of July will not be known until August 1, when all data for the calculation of that Hub Flow Index Average is available. However, the forward expectation in the energy market for the July Louisiana Hub Flow Index Average ranges between 1045 and 1055.

Many market participants proffer offers and bids to secure swap contracts for the July Louisiana Hub Flow Index Average, with most offers at the low end of the range and most bids at the high end of the range. Such bids and offers may be proffered on any viable trading system and in the preferred embodiment are proffered on an electronic trading system having connections to order entry systems.

In reference to the example, first party 900A and second party 900B reach agreement for a July Louisiana Hub Flow Index swap contract in which strike level 914 is 1050. Settlement of the contract is calculated by multiplying the difference between strike level 914 and the calculated price by some factor such as $1,000. First party 900A and second party 900B continue to hold that contract until July. When during July a major gas processing facility fails, natural gas flows in the region are reduced. At the end of July, the Hub Flow Index Average for the Louisiana market is computed as described above and equals 980. Thus the difference between strike level 914 of 1050 and the settlement level of 980 is 70. According to the contract between the parties, second party 900B would pay to first party 900A $70,000, representing the difference between strike level 914 and settlement level times $1,000. Thus, first party 900A is able to offset at least part of the financial detriment incurred by virtue of the processing plant damage.

Referring to FIG. 1, Market Index Average Engine 565 generates Market Indices 566 (including Hub Flow Index Averages and Energy Market Index Averages by using information from Market Models 545 and Market Index Average Templates 555. Market Index Average Engine 565 then delivers Market Indices 566 to the Web Portal 590 and/or Exchanges or Intermediaries 585.

The method of the present invention further provides for a mechanism for the selection, structure and formatting of energy flow data to be included in Market Indices 566. This mechanism is contained within Market Index Average Templates 555.

Market Index Average Templates 555 are preferably database tables containing instructions for the selection, structure and formatting of Market Indices 566. These instructions define how specific measurement points contained in Energy Data Catalog 530 are combined to create Market Indices 566. Market Index Average Template 555 corresponds to each Market Index 566 that is to be created. Each row in Market Index Average Template 555 corresponds to a unique measurement point in Energy Data Catalog 530 and indicates how flow data from that measurement point is to be deployed to create that specific Market Index 566.

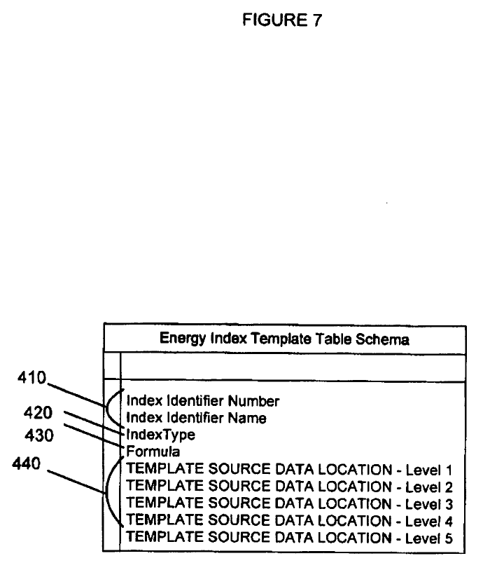

Market Index Average Engine 565 obtains the data required to assemble Market Index 566 from the appropriate Market Model 545. Market Index Average Engine 565 obtains Market Model data for the required time period(s) based on information such as that depicted in FIG. 7. It should be noted that in accordance with the preferred embodiment of the present invention, Template Source Data Location Fields 440 contain Levels 1-5 having fields which correspond to Levels 1-5 in Market Model Template Table Schema 201, depicted in FIG. 2.

Referring to FIG. 7, with respect to Energy Market Index Averages, the Index Type field will equal the number “1”. In this instance, Market Index Average Engine 565 then combines the measurement point level energy flow data according to instructions contained in the Formula Column 430. The contents of Formula Column 430 will be an instruction that indicates what is to be done with the data contained at the indicated Market Model data. For example, the instruction “+N” indicates that the data should be added to an accumulated sum. (In the formula, N=the measurement point level flow data to be included in the Energy Market Index Average calculation). The instruction “+(N*0.5)” indicates that the data should be multiplied by 0.5, then added to an accumulated sum. The instruction “−(N*0.3)” indicates that the data should be multiplied by 0.3, then subtracted from an accumulated sum. Of course, using the above guidelines one of ordinary skill in the art will understand the manipulation of the measurement point data. When Market Index Average Engine 565 has carried out the instructions for all rows in the Market Index Average Template 555 for a specific Market Index Average, the Market Index Average is assigned the value of the accumulated sum. Market Index Average Engine 565 then transmits the computed Market Index Average to Web Portal 590 for display to subscriber 595.

Still referring to FIG. 7, for Hub Flow Index Averages, the Index Type field will equal the number “2”. In this instance, Formula Column 430 will contain a list of Market Index Averages Index Identifiers 410 to be included in the Hub Flow Average. The set of such Market Index Average Index Identifiers in Formula Column 430 will be represented by a simple comma delimited list.

A Hub Flow Index Average is preferably computed using a set of Energy Market Index Averages selected to be representative of certain energy flows across energy Hubs in within a geographic region. This set of Energy Market Index Averages is specified in the list of Market Index Averages Index Identifiers described above.

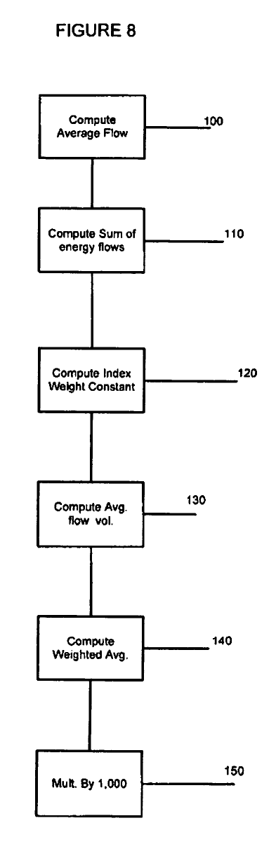

Referring now to FIG. 8, shown is a flow chart depicting the preferred embodiment for the calculation of a Hub Flow Index Average.

First, Average Hub Flow is computed 100 for each Energy Market Index Average (e.g., “Hub Locations”) to be included in the Hub Flow Index Average for the time period of interest, called the TPOI (the last day, week, month, etc.)

This may be represented by the formula:

$$Market Index Average for Hub \text{“} j \text{”} ( {MIA}_{j} ) = \frac{{\sum }_{i = 1}^{{n}_{j}} {x}_{ij}}{{n}_{j}}$$

$$\begin{matrix}Where \text{:} & n = the number of time periods \\ & in the Time Period of Intrest \\ & x = the gas flow for each period n\end{matrix}$$

Next, the sum of energy flows is computed 110 for each Hub Location over a period of time, called the Historical Period. For example, this sum will preferably be recomputed on January 1 of each subsequent year by using the most recent two years of Flow Data.

Third, Index Weight Constant is computed 120 for each Average Flow by dividing the sum of gas flows for the Historical Period for each Hub Location (calculated in the second step above) by the sum of gas flows for all for the historical period Hub Locations.

Next, Average Flow Volume is calculated 130 for the Historical Period called the Historical TPOI Average by dividing the total flow for the Hub Location over the historical period by the number of days in the historical period.

Next, Market Index Average for each Hub Location is divided by its respective Historical TPOI Average to calculate 140 the Component Index Average for each Hub Location. Weighted Average of the Component Index Averages is calculated using the respective Index Weight Constant for each Hub Location.

Finally, Weighted Average 840 is multiplied 150 by 1,000 to yield the Hub Flow Index Average.

As an example of the preferred embodiment of the present invention, a Hub Flow Index Average 850 is computed for natural gas flows in North America. In this exemplary Hub Flow Index, a set of Energy Market Index Averages may be used to compute this Hub Flow Index: Transco Zone 6 NY; Niagara, for North America NY; FGT Mkt Area Deliveries Transco Sta 65 (Louisiana); Tennessee Zone 0; Chicago City Gate; MICHCON; Northern Natural Gas Demarc; Panhandle Eastern Haven; Southern California Gas Average; Pacific Gas and Electric Citygate; Opal, Wyoming; Malin, Oregon; and Northwest Sumas (Washington). These Energy Market Index Averages may be revised from time to time as the energy market in North America changes.

The following example illustrates the above process. The Energy Market Index Averages whereby the time period of interest (TPOI) is the period of November 2005 to December 2005 are set forth below:

| Market Location | November 2005 | December 2005 | January 2006 |
|---|---|---|---|
| Transco Zone 6 NY | 1,313 | 1,815 | 1,642 |
| Niagara | 928 | 983 | 920 |
| FGT Mkt Area | 1,316 | 1,057 | 1,277 |
| Deliveries | | | |
| Transco Sta 65 | 2,178 | 2,650 | 2,398 |
| Tenn Zone 0 | 1,285 | 1,253 | 1,292 |
| Chicago CG | 3,025 | 3,459 | 2,678 |
| MICHCON | 380 | 349 | 170 |
| NNG Demarc | 1,575 | 1,664 | 1,602 |
| PEPL Haven | 1,307 | 1,326 | 1,308 |
| SOCAL Average | 2,120 | 2,036 | 2,420 |
| PG&E Citygate | 2,316 | 2,675 | 2,433 |
| OPAL | 1,237 | 1,270 | 1,178 |
| Malin | 936 | 1,212 | 889 |
| Northwest Sumas | 714 | 864 | 605 |

The historical flows for the period of 2004-2005 (the “Historical Period”) are calculated by adding the flows for 2004 and 2005, as set forth below. The Index Weight Constant for each market location is calculated by dividing the sum of gas flows for the Historical Period for each market location by the sum of energy flows for all market locations. The Historical TPOI Average is calculated by dividing the total flow by the number of days in the period.

| | | | Historical | Index | Historical |
|---|---|---|---|---|---|
| | | | Period | Weight | TPOI Avg |
| Market Location | 2004 | 2005 | 2004 + 05 | Constant | (Daily) |
| Transco Zone 6 NY | 528,527 | 523,817 | 1,052,344 | 7.11% | 1,440 |
| Niagara | 273,636 | 312,141 | 585,777 | 3.96% | 801 |
| FGT Mkt Area | 620,118 | 596,713 | 1,216,831 | 8.22% | 1,665 |
| Delveries | | | | | |
| Transco Sta 65 | 877,203 | 847,697 | 1,724,900 | 11.65% | 2,360 |
| Tenn Zone 0 | 305,079 | 395,078 | 700,157 | 4.73% | 958 |
| Chicago CG | 770,778 | 808,136 | 1,578,914 | 10.66% | 2,160 |
| MICHCON | 111,566 | 96,250 | 207,816 | 1.40% | 284 |
| NNG Demarc | 430,216 | 474,087 | 904,303 | 6.11% | 1,237 |
| PEPL Haven | 456,480 | 473,303 | 929,782 | 6.28% | 1,272 |
| SOCAL | 837,683 | 789,246 | 1,626,929 | 10.99% | 2,226 |
| PG&E Citygate | 982,166 | 876,934 | 1,859,100 | 12.56% | 2,543 |
| OPAL | 370,574 | 413,844 | 784,418 | 5.30% | 1,073 |
| Malin | 570,072 | 484,703 | 1,054,775 | 7.12% | 1,443 |
| Northwest Sumas | 297,784 | 283,390 | 581,173 | 3.92% | 795 |
| | 7,431,881 | 7,375,338 | 14,807,219 | 100.00% | 20,256 |

The Component Index Average is calculated by dividing the Market Index Average for each location by the Historical TPOI Average for each location.

| Hub | November 2005 | December 2005 | January 2006 |
|---|---|---|---|
| Transco Zone 6 NY | 0.911964 | 1.260449 | 1.140331 |
| Niagara | 1.157974 | 1.226694 | 1.147659 |
| FGT Mkt Area | 0.790368 | 0.634797 | 0.766919 |
| Delveries | | | |
| Transco Sta 65 | 0.922835 | 1.123262 | 1.016301 |
| Tenn Zone 0 | 1.341168 | 1.308332 | 1.349090 |
| Chicago CG | 1.400474 | 1.601398 | 1.239720 |
| MICHCON | 1.337365 | 1.227629 | 0.599366 |
| NNG Demarc | 1.273046 | 1.345190 | 1.294915 |
| PEPL Haven | 1.027631 | 1.042124 | 1.028415 |
| SOCAL Average | 0.952763 | 0.914994 | 1.087518 |
| PG&E Citygate | 0.910640 | 1.051889 | 0.956836 |
| OPAL | 1.153080 | 1.183493 | 1.097431 |
| Malin | 0.648917 | 0.839925 | 0.616227 |
| Northwest Sumas | 0.897580 | 1.086755 | 0.760693 |

The weighted average of the Component Index averages is computed using the Index Weight Constant for each location.

| Hub | November 2005 | December 2005 | January 2006 |
|---|---|---|---|
| Transco Zone 6 NY | 0.065 | 0.090 | 0.081 |
| Niagara | 0.046 | 0.049 | 0.045 |
| FGT Mkt Area | 0.065 | 0.052 | 0.063 |
| Delveries | | | |
| Transco Sta 65 | 0.108 | 0.131 | 0.118 |
| Tenn Zone 0 | 0.063 | 0.062 | 0.064 |
| Chicago CG | 0.149 | 0.171 | 0.132 |
| MICHCON | 0.019 | 0.017 | 0.008 |
| NNG Demarc | 0.078 | 0.082 | 0.079 |
| PEPL Haven | 0.065 | 0.065 | 0.065 |
| SOCAL Average | 0.105 | 0.101 | 0.119 |
| PG&E Citygate | 0.114 | 0.132 | 0.120 |
| OPAL | 0.061 | 0.063 | 0.058 |
| Malin | 0.046 | 0.060 | 0.044 |
| Northwest Sumas | 0.035 | 0.043 | 0.030 |
| | 1.02 | 1.12 | 1.03 |

Finally, the weighted average is calculated by multiplying by 1,000.

| | | | |
|---|---|---|---|
| HUB FLOW INDEX | 1,018 | 1,116 | 1,027 |

Referring again to FIG. 1, the method of the present invention further provides for a mechanism and procedure for the design and creation of Market Index Average Templates 555. In the preferred embodiment of the present invention, Market Index Average Templates 555 can be created for any aspect of an energy market where the required data is available in Market Model 545. The steps utilized in the design and creation of Market Index Average Templates 555 are described below.

First, an Energy Market Index Average Location is selected. More specifically, an Energy Market Index Average Location is a selected geographic area which contains energy flow data aggregated in Market Model 545. The location is preferably selected such that it is either a major trading location for natural gas as identified by various industry trade publications, or an access point between a major natural gas market or major natural gas producing area as identified by various industry trade publications.

Next, the rows in one or more Market Models 545 are selected to be aggregated to create an Energy Market Index Average. These rows are preferably selected based on an illustration or diagram that includes the Energy Market Index Average Location as created in the Creating Market Model Templates procedure described above.

Third, Energy Index Template Table Schema (depicted in FIG. 7) is accessed to determine the information in Formula Column 430 to be used for each row to be included to create an Energy Market Index Average. If the indicated flow typically enters the hub, the indicated formula should be “+”. If the indicated flow typically exits the hub, the indicated formula should be “−”. If only a portion of the flow enters or exits the hub, a multiplier (such as 0.5) should be used in the formula such as “+(N*0.5)”, indicating that only 50% of the flow enters the hub. In addition, the system determines Energy Market Index Averages to be aggregated to compute a Hub Flow Energy Average. Market Index Averages Index Identifiers 410 that are to be included in the Hub Flow Average are listed.

Next, Market Model Template Structure is coded within the Market Index Average Template Structure as described above. This process consists of the population of a database table configured in the manner described in FIG. 7.

Certain aspects of the Energy Visuals 575 and certain Energy Market Indices and Hub Flow Index Averages may be integrated with the functionality to implement energy purchase, sale and associated risk management decisions on-line via orders entered by “clicking through” an Energy Visuals data display. This Visual Energy Order Routing technology is preferable to other tabular forms of Energy Order Routing because it integrates information upon which market decisions are based with the mechanism used to implement those decisions. Such a trading user interface can be used by industry decision-makers to visualize energy market developments, assess these developments within the context of an energy market strategy and to implement energy trade orders, all within a single platform.

Visual Energy Order Routing allows buyers and sellers of energy products, commodities and derivatives to enter and/or consummate orders directly on an Energy Visuals display. Such derivative transactions may include contracts with settlement mechanisms based on Hub Flow Index Averages.

Referring again to FIG. 1, Order Entry Engine 580 combines Energy Visuals 575 with functionality that gives subscribers 595 the ability to view bid and ask prices, as well as the ability to enter bid and ask orders.

More specifically, the preferred embodiment of the present invention allows subscriber 595 to view bid and ask prices available at or referencing individual trading hubs in a map-based geographic context whereby prices, price differentials, energy flows, energy capacities and other information is displayed in a manner conducive to the understanding of continuously changing market interrelationships. In addition, subscriber 595 can enter bid and ask orders, or consummate orders within the map-based geographic context on an electronic energy exchange. Orders are entered or consummated by “clicking through” a specific hub, entering and confirming certain contractual information required for the specific instrument being traded, and electronically transmitting the order to the electronic energy exchange without leaving the map-based geographic context.

Energy Visuals 575 created by Geospatial Engine 570 can include energy prices sourced from Energy Price Feeds 525. Energy Price Feeds 525 are preferably delivered via Network 520 from energy exchange or intermediary 585 and can include prices for a variety of energy products, commodities and derivatives including derivative instruments with settlement mechanisms based on Hub Flow Index Averages. It is contemplated that Energy Price Feeds 525 can be delivered through any known or discovered means for collecting and categorizing information. In the preferred embodiment of the present invention, Energy Price Feeds 525 are delivered via an application programming interface (API) such using the industry standard Financial Information Exchange (FIX) protocol or other exchange specific protocol such as the Intercontinental Exchange (ICE) “Market Maker” API.

Such prices can be delivered periodically according to any frequency, including real-time. Accordingly, real-time prices from energy exchanges or intermediaries 585 can be presented to subscribers 595 via web portal 590 via Order Entry Engine 580 within the context of an Energy Visual 575.

Energy Visuals 575 having prices from energy exchanges or intermediaries 585 rendered by Order Entry Engine 580 can be used by subscribers 595 to “click through” a specific hub and effect a trade via the energy exchange or intermediary 585. That is, when subscriber 595 is viewing Energy Visual 575 and desires to view current trading prices associated with a commodity appearing on Energy Visual 575, subscriber 595 can actuate the visual representation of the commodity in order to display Order Entry Engine 580. In the preferred embodiment of the present invention, subscriber 595 actuates a portion of Energy Visual 575 by clicking the mouse cursor on the portion of Energy Visual 575 he or she wishes to actuate. Alternative embodiments of the present invention include various actuation means including, but not limited to, keyboard, joystick, touchscreen, mouse rollover, and light pen. Once subscriber 595 enters a trade order into Order Entry Engine 580 (via Web Portal 590), the order is transmitted via network 520 to exchange or intermediary 585 for execution. Orders are preferably delivered and confirmed via an application programming interface (API) such using the industry standard FIX protocol or other exchange specific protocol such as the ICE “Market Maker” API. If the order is executed, exchange or intermediary 585 returns the result via network 520 for presentation to subscriber 595 (via Web Portal 590).

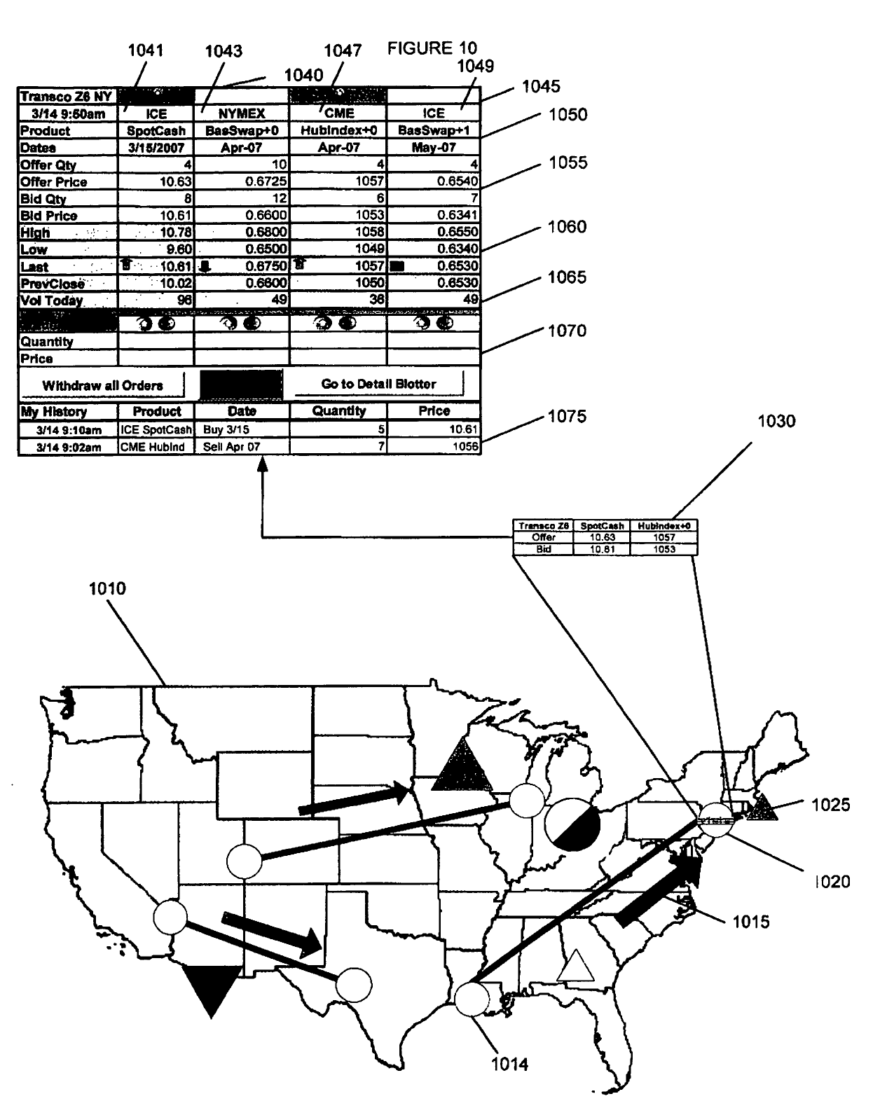

Referring now to FIG. 10, shown is Energy Visual 1010 similar to the one referenced above with respect to FIG. 5. Further depicted is first natural gas trading hub 1020 whereby pricing information 1030 was received from exchange or intermediary 585. Energy Visual 1010 could similarly display any number of trading hubs, for example any of FIGS. 13-16, 17A or 17B. Pricing information 1030 indicates the current bid and offer prices for two instruments traded on exchange or intermediary 585. In this example, there are bids and offers for a Spot Cash instrument and a Hub Flow Index Instrument.

FIG. 10 further depicts Dynamic Graphical Elements (e.g., 840 in FIG. 5) that indicate certain market trends at hub 1020. For example, green triangle 1025 indicates that the spot price at this hub has increased versus the previous trading session. Similarly, red arrow 1015 indicates the flow from the second hub 1014 to first hub 1020 has decreased versus the previous trading session. The process of creating and sizing these Dynamic Graphical Elements is described above.

Using price information 1030 and market information indicated by the Dynamic Graphical Elements including red arrow 1015 and green triangle 1025, subscriber 595 can assess the market at first hub 1020 in relation to price trends, flow trends and current bid-ask prices. Such information could suggest a trading opportunity for subscriber 595. If subscriber 595 desires to trade, subscriber 595 can click the mouse cursor on first hub 1020 to display trade blotter 1040. Trade Blotter 1040 includes information contained within Energy Visual 1030 as well as other instruments and additional information needed for subscriber 595 to make and implement trading decisions.

In this example, four instruments are shown: (a) a Spot Cash contract for delivery on Mar. 15, 2007 1041, (b) a Basis Swap contract for settlement during April 2007 1043, (c) a Hub Flow Index contract for settlement during April 2007 1047, and (d) a Basis Swap contract for settlement during May 2007 1049. These instruments would be preferentially available on an energy exchange previously selected by subscriber 595 as required.

All of the instruments shown in trade blotter 1040 can be optionally selected for display in Energy Visual 1030 by subscriber 595 as desired. In the preferred embodiment, subscriber 595 can click selection point 1045 to select instruments to be displayed on Energy Visual 1030. An icon appears indicating that instrument has been selected for display on Energy Visual 1030. Similarly, exchange, instrument, current date and time, and timeframe information are identified and selected at information point 1055. Pricing point 1055 displays the current bid quantity, bid price, offer quantity and offer price. Daily price point 1060 contains high, low, and last price information with respect to the contemporaneous trading session and the previous close price (from the previous trading session). Arrows indicate the direction of the current last price from the previous last price. Volume information point 1065 displays the volume traded in the current trading session. Subscriber 595 may enter the number of contracts to be traded and the price to be traded at trade information point 1070. Trades can be simultaneously entered for multiple instruments on one or more exchanges. To enter a trade, subscriber 595 clicks on an icon displayed at trade information point 1070 to indicate whether the trade is a bid (buy) or offer (sell), then indicates the quantity and price for that bid or offer. As indicated, subscriber enters an order by clicking a submit button at trade information point 1070, and can withdraw orders or can go to a detail blotter by clicking buttons at trade information point 1070. Such a Detail Blotter can be of any format typically used by any energy exchange such as the Intercontinental Exchange (ICE) WebICE blotter, the New York Mercantile Exchange (NYMEX) CME Globex blotter, etc. Contracts subscriber 595 has bought or sold are indicated at trade history point 1075.

The specifics of information in FIG. 10 are depicted as an example of data required to inform potential market participants and to execute trade orders. As would be recognized by one of ordinary skill in the art, these components can change to accommodate various energy market conditions and requirements.

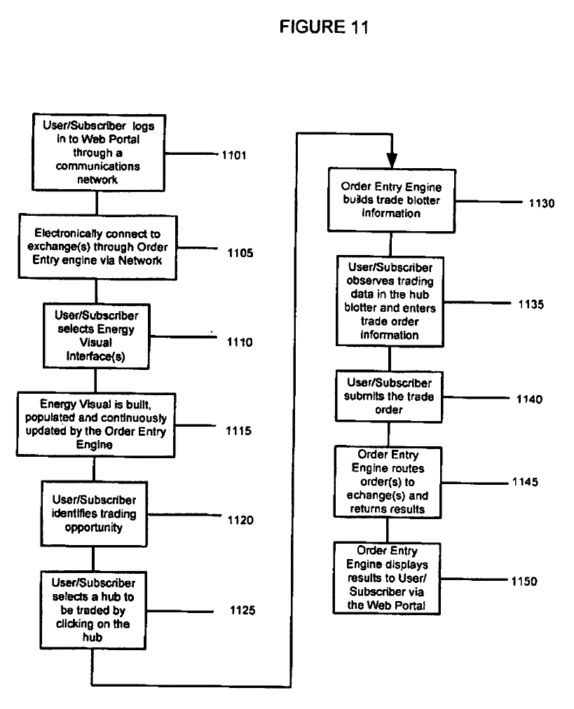

Referring now to FIG. 11, shown is visual energy trading in accordance with the preferred embodiment of the present invention. Subscriber 595 logs into to Web Portal 1101 in order to connect 1105 to or more exchanges through the Order Energy Engine 580 via a communications network. Subscriber 595 then selects 1110 one or more Energy Visual Interfaces and the Energy Visual is built, populated and continuously updated 1115 by Order Entry Engine 580. As subscriber 595 becomes informed about trends in the marketplace by visually analyzing the updating Energy Visual, subscriber 595 identifies a trading opportunity 1120 and selects a hub to be traded by actuating the hub 1125. The Order Entry Engine builds trade hub blotter information 1130 and subscriber 595 observes trading data in the hub blotter and enters trade order information including quantity and price 1135. Subscriber 595 then submits the trade order 1140 and the Order Entry Engine routes order(s) to exchange(s) and returns results 1145. Finally, Order Entry Engine displays results to subscriber 595 via the Web Portal 1150.

What is claimed is:

1) A method of producing a market model, said method comprising the steps of:
selecting at least one measurement point;
retrieving energy information from each of said measurement points; and
processing said energy information to create said market model.

2) The method of producing a market model according to claim 1, wherein said step of selecting at least one measurement point further comprises the steps of:
receiving user input identifying a requested Energy Visual;
processing said user input to identify a geographical location associated with said requested Energy Visual; and
utilizing said geographical location to select said measurement point.

3) The method of producing a market model according to claim 1, further comprising the step of:
storing said market model for utilization with associated Energy Visuals.

4) The method of producing a market model according to claim 1, further comprising the step of:
periodically storing said market model for utilization with associated Energy Visuals.

5) The method of producing a market model according to claim 1, further comprising the step of:
periodically compiling said market model for utilization with associated Energy Visuals and storing said compiled market model.

6) The method of producing a market model according to claim 1, wherein said step of retrieving energy information from each of said measurement points further comprises the steps of:
polling at least two external information sources;
extracting energy flow information from said external information sources; and
compiling said energy flow information to produce said energy information.

7) The method of producing a market model according to claim 1, wherein said step of processing said energy information to create said market model further comprises the steps of:
retrieving market model template information;
processing said market model template information to determine selection, structure and formatting of said market model; and
processing said energy information in accordance with said market model template information.

8) A method of producing a market model, said method comprising the steps of:
selecting at least one measurement point;
retrieving energy catalog information associated with energy data flow;
retrieving energy flow information from each of said measurement points; and
processing said energy information to create said market model.

9) The method of producing a market model according to claim 8, wherein said step of selecting at least one measurement point further comprises the steps of:
receiving user input identifying a requested Energy Visual;
processing said user input to identify a geographical location associated with said requested Energy Visual; and
utilizing said geographical location to select said measurement point.

10) The method of producing a market model according to claim 8, further comprising the step of:
storing said market model for utilization with associated Energy Visuals.

11) The method of producing a market model according to claim 8, further comprising the step of:
periodically storing said market model for utilization with associated Energy Visuals.

12) The method of producing a market model according to claim 8, further comprising the step of:
periodically compiling said market model for utilization with associated Energy Visuals and storing said compiled market model.

13) The method of producing a market model according to claim 8, wherein said step of retrieving energy information from each of said measurement point further comprises the steps of:
polling at least two external information sources;
extracting energy flow information from said external information sources; and
compiling said energy flow information to produce said energy information.

14) The method of producing a market model according to claim 8, wherein said step of processing said energy information to create said market model further comprises the steps of:
retrieving market model template information;
processing said market model template information to determine selection, structure and formatting of said market model; and
processing said energy information in accordance with said market model template information.
